(19) United States
(12) Patent Application Publication
(10) Pub. No.: US 2024/0409672 A1
(43) Pub. Date: Dec. 12, 2024

(54) MODIFIED ALGINATES AND METHODS OF MAKING AND USING THEREOF

(71) Applicant: NORTH CAROLINA STATE UNIVERSITY, RALEIGH, NC (US)

(72) Inventors: Yevgeny Brudno, Raleigh, NC (US); Christopher Moody, Raleigh, NC (US)

(21) Appl. No.: 18/704,343

(22) PCT Filed: Oct. 28, 2022
(86) PCT No.: PCT/US2022/078944

§ 371 Date: Apr. 24, 2024

Related U.S. Application Data
(60) Provisional application No. 63/272,973, filed on Oct. 28, 2021.
(60) Provisional application No. 63/288,906, filed on Dec. 13, 2021.

(51) Int. Cl. C08B 37/00; C08J 3/075; C08J 3/24

(52) U.S. Cl. CPC C08B 37/0084; C08J 3/075; C08J 3/24

(57) ABSTRACT

The loss of cross-linking abilities in highly substituted alginate scaffolds is a significant problem affecting the use of alginate polymers in implants, cell delivery, and tissue engineering. Disclosed are modified alginate scaffolds that retain their gelation properties under high chemical modification, as well as methods of making and using thereof.

### CROSS-REFERENCE TO RELATED APPLICATIONS

This application claims benefit of U.S. Provisional Application No. 63/272,975, filed Oct. 28, 2021, and U.S. Provisional Application No. 63/288,906, filed Dec. 13, 2021, each of which is hereby incorporated herein by reference in its entirety.

### STATEMENT REGARDING FEDERALLY SPONSORED RESEARCH OR DEVELOPMENT

This invention was made with government support under Grant No. CA246414 awarded by the National Institutes of Health. The government has certain rights in the invention.

### BACKGROUND

Hydrogel biomaterials offer utility in biomedical applications due to their stability, tunable mechanics and degradation profiles, as well as biocompatibility with surrounding tissues. Clinical and preclinical applications of hydrogel biomaterials include tissue engineered constructs, depots for drug and cell delivery, and cellular scaffolds used in the study of biological processes.

Among hydrogels, alginate is rapidly gaining attention because it gels under neutral, physiological conditions, exhibits good biocompatibility at tissue sites, and has wide chemical versatility. Alginate gelation utilizes ionic cross-links between the carboxyl groups on alginate and divalent cations. The calcium cross-linked hydrogels are injectable and self-healing, enabling facile injection into tissues. In vivo, calcium cross-linked alginate hydrogels elicits low levels of foreign body responses, very low toxicity and limited immunogenicity. In addition, alginate is generally recognized as safe (GRAS) by the FDA, which has motivated alginates preclinical testing to deliver drugs, biologicals, viruses and cells and clinically as a dietary supplement, material for wound dressings, sealant agent and as an injectable implant.

The chemical versatility of alginate is of particular interest to researchers trying to take advantage of alginate's biocompatibility. Chemical modification of alginate has been used to decorate alginate polymers with small molecules for controlled and tunable drug delivery and with peptides and proteins to mediate cell attachment and signaling. More recently, alginate polymers have been conjugated to bioorthogonal “click” chemical motifs in order to enhance or enable alginate cross-linking, to expedite polymer modification, and to create targetable drug depots.

Although alginate is straightforward to chemically modify, modification carries undesired complications. Most frequently, alginate polymers are modified through carbodiimide coupling between the carboxyl group on alginate and nucleophiles (alcohols, amines, and others). Unfortunately, this chemical modification decreases polymer viscosity and can inhibit gelation. Indeed, alginate hydrogels modified to a high degree of substitution (DS) suffer from poor or nonexistent calcium cross-linking. What is needed are new methods of modifying alginate that do not suffer from the drawbacks currently experienced when modifying alginate with a high DS.

### SUMMARY

Disclosed are alginate strands with a high degree of substitution and methods of making the same.

In one aspect disclosed herein are substituted alginate strands comprising alginate strands coupled to a functional moiety (e.g., a click motif, such as, for example, an azide) via a linker, wherein the linker comprises a nucleophilic terminus (such as, for example, amino, alcohol, thiol) and additionally a carboxyl group attached to the linker; and wherein the nucleophilic terminus is coupled to a carboxyl group on the alginate strand. In some aspects, the substituted alginate strands can form polymer strands.

In one aspect, disclosed herein are methods of coupling an alginate strand to an functional moiety (e.g., a click motif, such as, for example, an azide) via carbodiimide coupling said method comprising conjugating the functional moiety to a linker comprising a nucleophilic terminus and a carboxyl group of the nucleophilic terminus of the linker (such as, amine, alcohol, thiol); wherein the functional moiety is chemically coupled to the linker at the opposing end to the nucleophilic terminus; and coupling the nucleophilic terminus of the linker to the alginate strand via carbodiimide coupling; wherein the modification allows for synthesis of highly substituted alginate; wherein the substitution does not disrupt the integrity of the gel.

Also disclosed herein are methods of coupling an alginate strand to an functional moiety (e.g., a click motif, such as, for example, an azide) of any preceding aspect, wherein the nucleophilic terminus of the linker comprise a protecting group (such as, for example, methyl, ethyl, benzyl, benzyloxycarbonyl, s-Butyl, 2-Alkyl-1,3-oxazoline, OBO, silyl, photo-sensitive group propyl, tert-butyl, and NVOC); and wherein the nucleophilic terminus is deprotected prior to being coupled to a sugar on the alginate strand.

Also disclosed herein are methods of coupling an alginate strand to an functional moiety of any preceding aspect, wherein the carboxyl group on the linker is modified with a protecting group (such as, for example, methyl, ethyl, benzyl, benzyloxycarbonyl, s-Butyl, 2-Alkyl-1,3-oxazoline, OBO, silyl, photo-sensitive group propyl, tert-butyl, and NVOC); and wherein the carboxyl group may be deprotected after the coupling to the alginate strand.

Also disclosed are modified alginates comprising one or more covalently modified monomers defined by Formula I

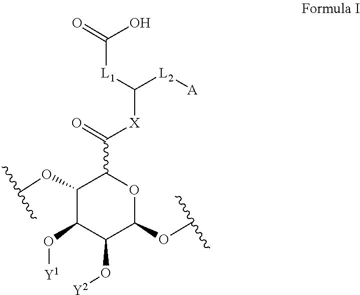

wherein:
X is O, S, or NR₃;
R³ is hydrogen, alkyl, alkenyl, alkynyl, aryl, heteroaryl, cycloalkyl, or heterocycloalkyl;
L₁ and L₂ are each independently absent or represent a linking group;
A represents a functional moiety (e.g., a click motif or an active agent); and
Y₁ and Y₂ independently are hydrogen or —PO(OR)₂, or Y₂ is absent, and Y₁, together with the two oxygen atoms to which Y₁ and Y₂ are attached form a cyclic structure as shown below

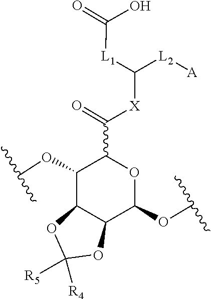

wherein
wherein R₄ and R₅ are, independently, hydrogen, alkyl, alkenyl, alkynyl, aryl, heteroaryl, cycloalkyl, heterocycloalkyl, alkoxy, aroxy, alkylthio, carbonyl, carboxyl, amino, or amido; or R₄ and R₅, together with the carbon atom to which they are attached, form a 3- to 8-membered unsubstituted or substituted carbocyclic or heterocyclic ring.

Also disclosed herein are hydrogel matrixes or scaffolds comprising polymer strands of the substituted alginate strand of any preceding aspect or the modified alginates of any preceding aspect, wherein the polymer strands are cross-linked to other alginate polymer stands via a divalent metal cation (e.g., via calcium crosslinking).

### BRIEF DESCRIPTION OF THE DRAWINGS

The accompanying drawings, which are incorporated in and constitute a part of this specification, illustrate several embodiments and together with the description illustrate the disclosed compositions and methods.

FIG. 1A shows an overview of depletive and restorative alginate modifications. Alginate can be modified with chemical groups (blue) through the carboxyl groups (red), which depletes the carboxyl groups, and destroys calcium cross-linking. In contrast, if the modifications restore carboxyl groups, alginate gels maintain calcium cross-linking and gelation.

FIG. 1B shows a representation of cross-linking that occurs in traditional unmodified alginate gels.

FIG. 1C shows the effect of modification on alginate cross-linking.

FIG. 1D shows the present solution of introducing new carboxylic acid groups and the effect of said groups on cross-linking.

FIG. 2 shows the synthetic approach to (S)-2-ammonio-6-(2-azidoacetamido)hexanoate (S4).

FIG. 3 shows the coupling of azide-amine (depletive modification) and azide-lysine (restorative modification) to alginate.

FIGS. 4A, 4B, 4C, and 4D show restorative modifications at high degrees of substitution maintain alginate gel mechanics. FIG. 4A shows photos of calcium cross-linked alginate gels using depletive or restorative modifications at low- and high-DS azide. FIG. 4B shows representative strain sweep of calcium cross-linked alginate gels with restorative modifications (linearity limit of γ_{L}=24%) showing viscoelastic behavior. N=3 for each gel as well as carboxyl-depleted and unmodified hydrogel can be found in FIG. 5. ±5% tolerance range of deviation was used to select the plateau value of the linearity limit. FIG. 4C shows representative frequency sweeps [1-100 Hz] within the LVE region showing the gel-like behavior and structural stability of calcium cross-linked gels modified with high-DS restored azide-alginate and high-DS depleted azide-alginate. Storage modulus (G′) and loss modulus (G″) measurements are shown. N=3 for each gel and low-DS gel mechanics can be found in FIG. 6. FIG. 4D shows cyclic strain time sweep rheology showing self-healing behavior of calcium cross-linked alginate gels with restorative modifications demonstrated by the recovery after repeated deformation of high strain [500%] followed by low strain [0.2%] (frequency=10 Hz). N=3 for each gel type as well as unmodified and carboxyl-depleted gels are shown in FIG. 8

FIGS. 5A, 5B, and 5C show the viscoelastic properties and linearity limits shown by 10 Hz strain sweeps of calcium cross-linked alginate gels with (5A) restorative modifications (N=3) γ_{L-RM}=26%, (5B) depletive modifications (N=3), and (5C) unmodified (N=2) γ_{L-control}=5%. ±5% tolerance range of deviation was used to select the plateau value of the linearity limit.

FIGS. 6A and 6B show frequency Sweep [1-100 Hz] of calcium cross-linked gels showing gel-like status and structural stability. Storage modulus (G′) and loss modulus (G″) measurements are shown. FIG. 6A shows one sample from each gel group including low-DS gels and unmodified. FIG. 6B shows all samples of all gel groups shown. N=3

FIG. 7 shows rotational test showing injectability of unmodified alginate (N=2) and alginate with high degree of substitution using restorative modification (N=3). Continuous shear rate ramps from 50 to 0 s-1 for 2.5 minutes were performed to study the continuous flow behavior of the gel. Total of 74 data points with 20 data points per decade was recorded.

FIGS. 8A, 8B, and 8C show the self-healing behavior of calcium cross-linked alginate gels demonstrated by the recovery after repeated deformation of high strain [500%] at 10 Hz followed by low strain [0.2%]. FIG. 8A shows calcium cross-linked alginate with high azide DS using restorative and depletive modification. N=3. FIG. 8B shows one sample of calcium cross-linked alginate with high and low DS using restorative and depletive modification. N=1. FIG. 8C shows calcium cross-linked unmodified alginate. N=1.

FIGS. 9A, 9B, 9C, 9D, and 9E show calcium cross-linked alginate gels with restorative azide modification reduce off-target gel migration. FIG. 9A shows representative images (same BLI scale) and FIG. 9B shows quantitation of fluorescence signal after intramuscular injection of alginate hydrogels fluorescently conjugated to carboxyl-depletive or -restorative modifications over 2 weeks. Unmodified alginates with unconjugated fluorophore served as negative control. FIG. 9C shows representative locations for quantified off-target migration. Quantitation of fluorescence signal in non-injected contralateral limb (9D) and ankle (9E) over 2 weeks. Region of interest (ROI) values were quantified as total radiance efficiency in equivalent sized regions. Figures show mean±SEM. Statistical significance represented as ***p<0.001, and ****p<0.0001 by two-way ANOVA followed by Tukey's multiple comparison test as compared to negative control. N=4. Full images of all mice can be found in FIG. 10.

FIG. 10 shows calcium cross-linked alginate gels with restorative azide modification improve retention at injection sites as compared to alginate gels with no modification. All mouse images of fluorescence signal after intramuscular injection of alginate hydrogels fluorescently conjugated to carboxylate-depleting or -restoring modifications over 2 weeks. Unmodified alginates with unconjugated fluorophore served as negative control. Images shown of each group at the same scale. All fluorescent signal was measured using ICG/ICG filter and shown as radiance efficiency. N=4.

FIGS. 11A and 11B show restorative azide modification improves on-target capture of circulating DBCO fluorophores. FIG. 11A shows representative images (same BLI scale) and 11B shows quantitation of fluorescence at intramuscular sites from i.m.-injected alginate hydrogels cross-linked with calcium. DBCO-Cy7 was administered i.v. one week following gel injection. One week following i.v. administration, mice were imaged to compare the capture of the fluorescent signal at the injected site. ROI values were quantified as total radiance efficiency in equivalent sized regions. Samples show mean±SEM. Statistical significance represented as **p<0.01, and ****p<0.0001 by one-way ANOVA followed by Tukey's multiple comparison test of all groups. N=3.

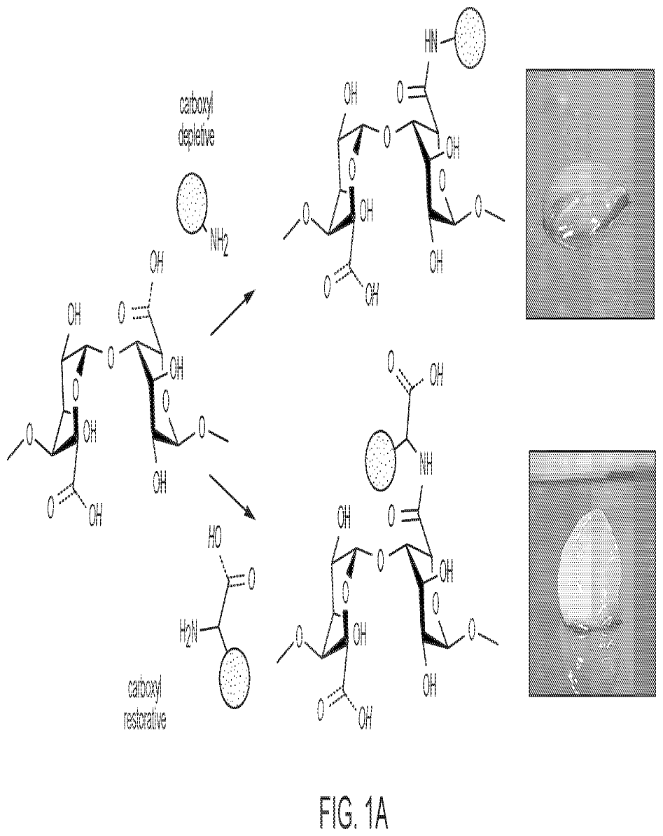

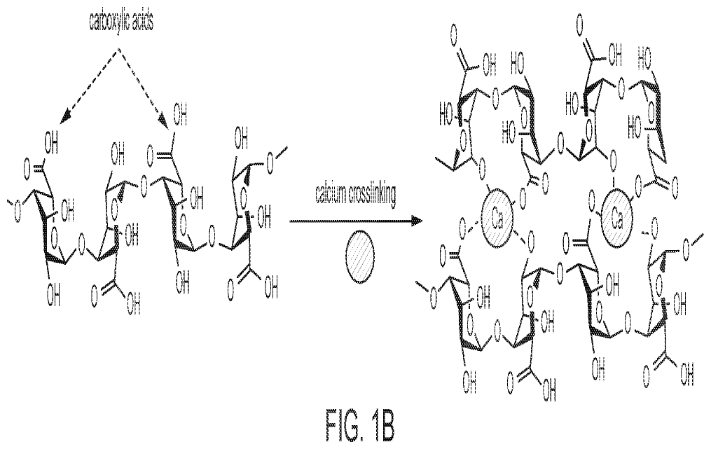

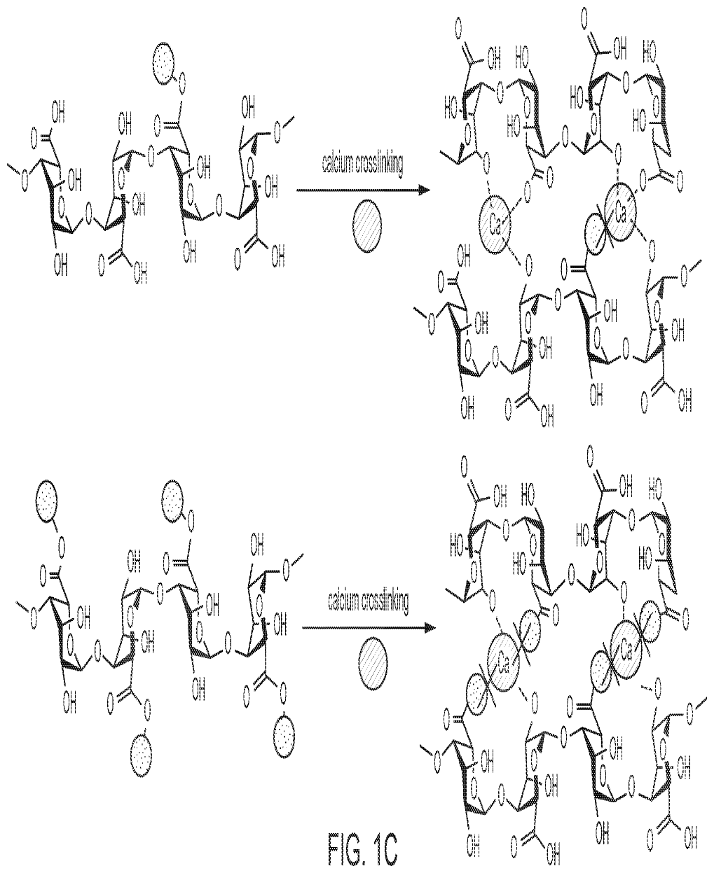

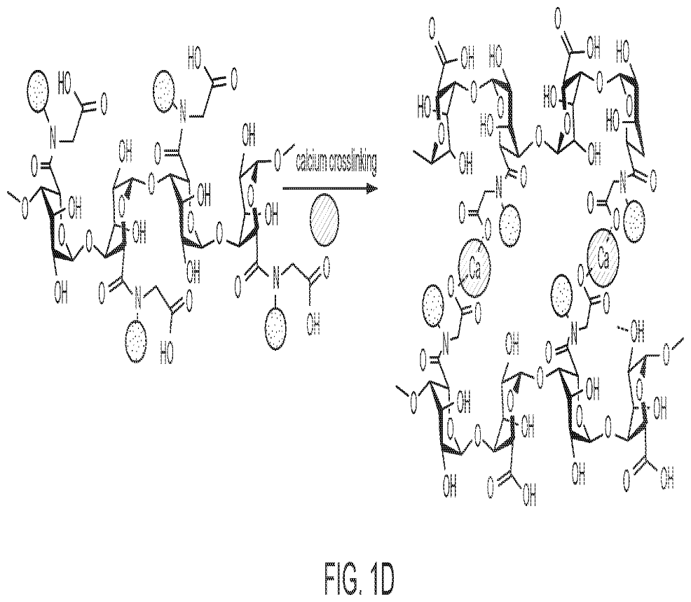

### DETAILED DESCRIPTION

Before the present compounds, compositions, articles, devices, and/or methods are disclosed and described, it is to be understood that they are not limited to specific synthetic methods or specific recombinant biotechnology methods unless otherwise specified, or to particular reagents unless otherwise specified, as such may, of course, vary. It is also to be understood that the terminology used herein is for the purpose of describing particular embodiments only and is not intended to be limiting.

### Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10”as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

An “increase” can refer to any change that results in a greater amount of a symptom, disease, composition, condition or activity. An increase can be any individual, median, or average increase in a condition, symptom, activity, composition in a statistically significant amount. Thus, the increase can be a 1, 2, 3, 4, 5, 6, 7, 8, 9, 10, 15, 20, 25, 30, 35, 40, 45, 50, 55, 60, 65, 70, 75, 80, 85, 90, 95, or 100% increase so long as the increase is statistically significant.

A “decrease” can refer to any change that results in a smaller amount of a symptom, disease, composition, condition, or activity. A substance is also understood to decrease the genetic output of a gene when the genetic output of the gene product with the substance is less relative to the output of the gene product without the substance. Also for example, a decrease can be a change in the symptoms of a disorder such that the symptoms are less than previously observed. A decrease can be any individual, median, or average decrease in a condition, symptom, activity, composition in a statistically significant amount. Thus, the decrease can be a 1, 2, 3, 4, 5, 6, 7, 8, 9, 10, 15, 20, 25, 30, 35, 40, 45, 50, 55, 60, 65, 70, 75, 80, 85, 90, 95, or 100% decrease so long as the decrease is statistically significant.

“Inhibit,” “inhibiting,” and “inhibition” mean to decrease an activity, response, condition, disease, or other biological parameter. This can include but is not limited to the complete ablation of the activity, response, condition, or disease. This may also include, for example, a 10% reduction in the activity, response, condition, or disease as compared to the native or control level. Thus, the reduction can be a 10, 20, 30, 40, 50, 60, 70, 80, 90, 100%, or any amount of reduction in between as compared to native or control levels.

By “reduce” or other forms of the word, such as “reducing” or “reduction,” is meant lowering of an event or characteristic (e.g., tumor growth). It is understood that this is typically in relation to some standard or expected value, in other words it is relative, but that it is not always necessary for the standard or relative value to be referred to. For example, “reduces tumor growth” means reducing the rate of growth of a tumor relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed.

The term “subject” refers to any individual who is the target of administration or treatment. The subject can be a vertebrate, for example, a mammal. In one aspect, the subject can be human, non-human primate, bovine, equine, porcine, canine, or feline. The subject can also be a guinea pig, rat, hamster, rabbit, mouse, or mole. Thus, the subject can be a human or veterinary patient. The term “patient” refers to a subject under the treatment of a clinician, e.g., physician.

The term “therapeutically effective” refers to the amount of the composition used is of sufficient quantity to ameliorate one or more causes or symptoms of a disease or disorder. Such amelioration only requires a reduction or alteration, not necessarily elimination.

The term “treatment” refers to the medical management of a patient with the intent to cure, ameliorate, stabilize, or prevent a disease, pathological condition, or disorder. This term includes active treatment, that is, treatment directed specifically toward the improvement of a disease, pathological condition, or disorder, and also includes causal treatment, that is, treatment directed toward removal of the cause of the associated disease, pathological condition, or disorder. In addition, this term includes palliative treatment, that is, treatment designed for the relief of symptoms rather than the curing of the disease, pathological condition, or disorder; preventative treatment, that is, treatment directed to minimizing or partially or completely inhibiting the development of the associated disease, pathological condition, or disorder; and supportive treatment, that is, treatment employed to supplement another specific therapy directed toward the improvement of the associated disease, pathological condition, or disorder.

“Biocompatible” generally refers to a material and any metabolites or degradation products thereof that are generally non-toxic to the recipient and do not cause significant adverse effects to the subject.

“Comprising” is intended to mean that the compositions, methods, etc. include the recited elements, but do not exclude others. “Consisting essentially of” when used to define compositions and methods, shall mean including the recited elements, but excluding other elements of any essential significance to the combination. Thus, a composition consisting essentially of the elements as defined herein would not exclude trace contaminants from the isolation and purification method and pharmaceutically acceptable carriers, such as phosphate buffered saline, preservatives, and the like. “Consisting of” shall mean excluding more than trace elements of other ingredients and substantial method steps for administering the compositions provided and/or claimed in this disclosure. Embodiments defined by each of these transition terms are within the scope of this disclosure.

A “control” is an alternative subject or sample used in an experiment for comparison purposes. A control can be “positive” or “negative.”

“Effective amount” of an agent refers to a sufficient amount of an agent to provide a desired effect. The amount of agent that is “effective” will vary from subject to subject, depending on many factors such as the age and general condition of the subject, the particular agent or agents, and the like. Thus, it is not always possible to specify a quantified “effective amount.” However, an appropriate “effective amount” in any subject case may be determined by one of ordinary skill in the art using routine experimentation. Also, as used herein, and unless specifically stated otherwise, an “effective amount” of an agent can also refer to an amount covering both therapeutically effective amounts and prophylactically effective amounts. An “effective amount” of an agent necessary to achieve a therapeutic effect may vary according to factors such as the age, sex, and weight of the subject. Dosage regimens can be adjusted to provide the optimum therapeutic response. For example, several divided doses may be administered daily or the dose may be proportionally reduced as indicated by the exigencies of the therapeutic situation.

A “pharmaceutically acceptable” component can refer to a component that is not biologically or otherwise undesirable, i.e., the component may be incorporated into a pharmaceutical formulation provided by the disclosure and administered to a subject as described herein without causing significant undesirable biological effects or interacting in a deleterious manner with any of the other components of the formulation in which it is contained. When used in reference to administration to a human, the term generally implies the component has met the required standards of toxicological and manufacturing testing or that it is included on the Inactive Ingredient Guide prepared by the U.S. Food and Drug Administration.

“Pharmaceutically acceptable carrier” (sometimes referred to as a “carrier”) means a carrier or excipient that is useful in preparing a pharmaceutical or therapeutic composition that is generally safe and non-toxic and includes a carrier that is acceptable for veterinary and/or human pharmaceutical or therapeutic use. The terms “carrier” or “pharmaceutically acceptable carrier” can include, but are not limited to, phosphate buffered saline solution, water, emulsions (such as an oil/water or water/oil emulsion) and/or various types of wetting agents. As used herein, the term “carrier” encompasses, but is not limited to, any excipient, diluent, filler, salt, buffer, stabilizer, solubilizer, lipid, stabilizer, or other material well known in the art for use in pharmaceutical formulations and as described further herein.

“Pharmacologically active” (or simply “active”), as in a “pharmacologically active” derivative or analog, can refer to a derivative or analog (e.g., a salt, ester, amide, conjugate, metabolite, isomer, fragment, etc.) having the same type of pharmacological activity as the parent compound and approximately equivalent in degree.

“Therapeutic agent” refers to any composition that has a beneficial biological effect. Beneficial biological effects include both therapeutic effects, e.g., treatment of a disorder or other undesirable physiological condition, and prophylactic effects, e.g., prevention of a disorder or other undesirable physiological condition (e.g., a non-immunogenic cancer). The terms also encompass pharmaceutically acceptable, pharmacologically active derivatives of beneficial agents specifically mentioned herein, including, but not limited to, salts, esters, amides, proagents, active metabolites, isomers, fragments, analogs, and the like. When the terms “therapeutic agent” is used, then, or when a particular agent is specifically identified, it is to be understood that the term includes the agent per se as well as pharmaceutically acceptable, pharmacologically active salts, esters, amides, proagents, conjugates, active metabolites, isomers, fragments, analogs, etc.

“Therapeutically effective amount” or “therapeutically effective dose” of a composition (e.g. a composition comprising an agent) refers to an amount that is effective to achieve a desired therapeutic result. In some embodiments, a desired therapeutic result is the control of type I diabetes. In some embodiments, a desired therapeutic result is the control of obesity. Therapeutically effective amounts of a given therapeutic agent will typically vary with respect to factors such as the type and severity of the disorder or disease being treated and the age, gender, and weight of the subject. The term can also refer to an amount of a therapeutic agent, or a rate of delivery of a therapeutic agent (e.g., amount over time), effective to facilitate a desired therapeutic effect, such as pain relief. The precise desired therapeutic effect will vary according to the condition to be treated, the tolerance of the subject, the agent and/or agent formulation to be administered (e.g., the potency of the therapeutic agent, the concentration of agent in the formulation, and the like), and a variety of other factors that are appreciated by those of ordinary skill in the art. In some instances, a desired biological or medical response is achieved following administration of multiple dosages of the composition to the subject over a period of days, weeks, or years.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

### Compositions and Methods

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular substituted alginate strand or modified functional moiety is disclosed and discussed and a number of modifications that can be made to a number of molecules including the substituted alginate strand or modified functional moiety are discussed, specifically contemplated is each and every combination and permutation of substituted alginate strand or modified functional moiety and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

Alginates are versatile polysaccharide based polymers that may be formulated for specific applications by controlling the molecular weight, rate of degradation and method of scaffold formation. Alginate molecules are comprised of (1-4)-linked β-D-mannuronic acid (M units) and α L-guluronic acid (G units) monomers, which can vary in proportion and sequential distribution along the polymer chain. “Alginate’, as used herein, is a collective term used to refer to linear polysaccharides formed from -D-mannuronate and L-guluronate in any M/G ratio, as well as salts and derivatives thereof. The term “alginate”, as used herein, encompasses any polymer having the structure shown below, as well as salts thereof.

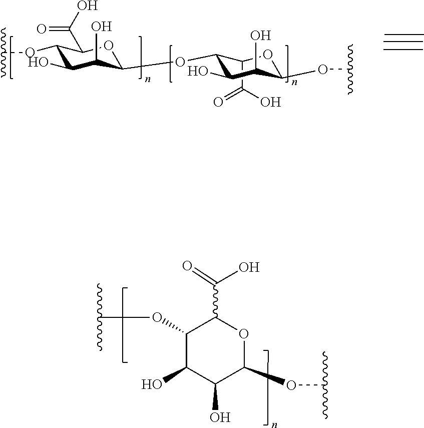

“Mannuronate” and “Mannuronate Monomer”, as used herein, refer to mannuronic acid monomers as well as salts thereof.

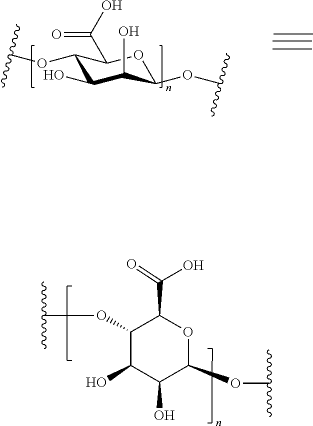

“Guluronate and -Guluronate Monomer”, as used herein refer to guluronic acid monomers as well as salts thereof.

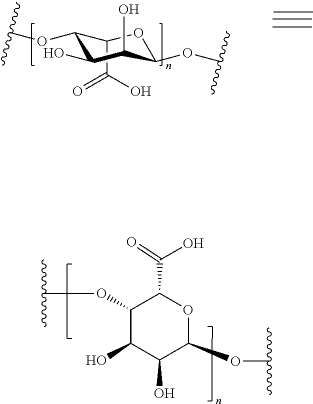

“Chemically Modified Alginate’ or “Modified Alginate, are used herein interchangeably, and refer to alginate polymers which contain one or more covalently modified monomers. “Covalently Modified Monomer’, as used herein, refers to a monomer which is an analog or derivative of a mannuronate and/or guluronate monomer obtained from a mannuronate and/or guluronate monomer via a chemical process.

“Singularly Modified Alginate Polymer, as used herein, refers to modified alginates that contain one or more covalently modified monomers, wherein substantially all of the covalently modified monomers possess the same covalent modification (i.e., the polymer contains one type or species of covalently modified monomer). Singularly modified alginate polymers include, for example, modified alginate polymers wherein substantially all of the monomers in the modified alginate polymer are represented by mannuronate monomers, guluronate monomers, and a covalently modified monomer defined by Formula I described below. Not all of the monomers are necessarily covalently modified.

“Multiply Modified Alginate Polymer”, as used herein, refers to modified alginates that contain covalently modified monomers, wherein substantially all of the covalently modified monomers do not possess the same covalent modification (i.e., the polymer contains two or more different ‘types’ or species of covalently modified monomers). Multiply modified alginate polymers include, for example, modified alginate polymers wherein substantially all of the monomers in the modified alginate polymer are represented by mannuronate monomers, guluronate monomers, and two or more different types of covalently modified monomers defined by Formula I. As used in this context, a ‘type’ or ‘species’ of covalently modified monomer refers to a covalent monomer defined by Formula I, wherein all possible variable positions are chemically defined. Not all the monomers need be covalently modified.

For clarity of discussion herein, singularly modified alginates are defined using formulae illustrating the structure of the covalently modified monomers incorporated in the backbone and omitting the mannuronate and guluronate monomers. For example, a singularly modified alginate polymer composed of mannuronate monomers, guluronate monomers, and a covalently modified monomer defined by Formula I, wherein X is NH, L₁ is absent, L₂ is —CH2-CH₂—CH₂—CH₂—NH—CO—CH₂—, A is an azide, and Y₁, and Y₂ are hydrogen, is illustrated herein by the structure below.

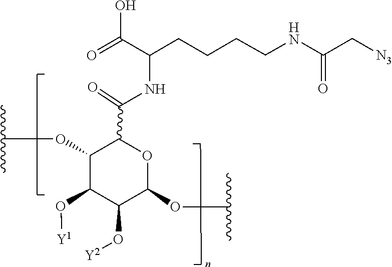

“Substituted,” as used herein, refers to all permissible substituents of the compounds or functional groups described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, aminoacid, peptide, and polypeptide groups.

Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc.

“Aryl,” as used herein, refers to C₅-C₁₀-membered aromatic, heterocyclic, fused aromatic, fused heterocyclic, biaromatic, or bihetereocyclic ring systems. Broadly defined, “aryl,” as used herein, includes 5-, 6-, 7-, 8-, 9-, and 10-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.” The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

“Aryl” further encompasses polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl.”

“Alkyl,” as used herein, refers to the radical of saturated or unsaturated aliphatic groups, including straight-chain alkyl, alkenyl, or alkynyl groups, branched-chain alkyl, alkenyl, or alkynyl groups, cycloalkyl, cycloalkenyl, or cycloalkynyl (alicyclic) groups, alkyl substituted cycloalkyl, cycloalkenyl, or cycloalkynyl groups, and cycloalkyl substituted alkyl, alkenyl, or alkynyl groups. Unless otherwise indicated, a straight chain or branched chain alkyl has 30 or fewer carbon atoms in its backbone (e.g., C₁-C₃₀ for straight chain, C₃-C₃₀ for branched chain), preferably 20 or fewer, more preferably 10 or fewer, most preferably 6 or fewer. If the alkyl is unsaturated, the alkyl chain generally has from 2-30 carbons in the chain, preferably from 2-20 carbons in the chain, more preferably from 2-10 carbons in the chain. Likewise, preferred cycloalkyls have from 3-20 carbon atoms in their ring structure, preferably from 3-10 carbons atoms in their ring structure, most preferably 5, 6 or 7 carbons in the ring structure.

The terms “alkenyl” and “alkynyl” refer to unsaturated aliphatic groups analogous in length and possible substitution to the alkyls described above, but that contain at least one double or triple bond respectively.

“Alkyl” includes one or more substitutions at one or more carbon atoms of the hydrocarbon radical as well as heteroalkyls. Suitable substituents include, but are not limited to, halogens, such as fluorine, chlorine, bromine, or iodine; hydroxyl; —NR₁R₂, wherein R₁ and R₂ are independently hydrogen, alkyl, or aryl, and wherein the nitrogen atom is optionally quaternized; —SR, wherein R is hydrogen, alkyl, or aryl; —CN; —NO₂; —COOH; carboxylate; —COR, —COOR, or —CONR₂, wherein R is hydrogen, alkyl, or aryl; azide, aralkyl, alkoxyl, imino, phosphonate, phosphinate, silyl, ether, sulfonyl, sulfonamido, heterocyclyl, aromatic or heteroaromatic moieties, —CF₃; —CN; —NCOCOCH₂CH₂, —NCOCOCHCH; —NCS; and combinations thereof.

“Amino” and “Amine,” as used herein, are art-recognized and refer to both substituted and unsubstituted amines, e.g., a moiety that can be represented by the general formula:

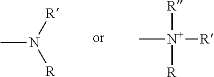

wherein, R, R′, and R″ each independently represent a hydrogen, substituted or unsubstituted alkyl, substituted or unsubstituted alkenyl, substituted or unsubstituted alkynyl, substituted or unsubstituted carbonyl, —(CH₂)ₘ—R′″, or R and R′ taken together with the N atom to which they are attached complete a heterocycle having from 3 to 14 atoms in the ring structure; R′″ represents a hydroxy group, substituted or unsubstituted carbonyl group, an aryl, a cycloalkyl ring, a cycloalkenyl ring, a heterocycle, or a polycycle; and m is zero or an integer ranging from 1 to 8. In preferred embodiments, only one of R and R′ can be a carbonyl, e.g., R and R′ together with the nitrogen do not form an imide. In preferred embodiments, R and R′ (and optionally R″) each independently represent a hydrogen atom, substituted or unsubstituted alkyl, a substituted or unsubstituted alkenyl, or -(CH₂)ₘ—R′″. Thus, the term ‘alkylamine’ as used herein refers to an amine group, as defined above, having a substituted or unsubstituted alkyl attached thereto (i.e. at least one of R, R′, or R″ is an alkyl group).

“Carbonyl,” as used herein, is art-recognized and includes such moieties as can be represented by the general formula:

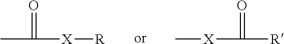

wherein X is a bond, or represents an oxygen or a sulfur, and R represents a hydrogen, a substituted or unsubstituted alkyl, substituted or unsubstituted alkenyl, substituted or unsubstituted alkynyl, —(CH₂)ₘ—R″, or a pharmaceutical acceptable salt, R′ represents a hydrogen, substituted or unsubstituted alkyl, substituted or unsubstituted alkenyl, substituted or unsubstituted alkynyl, or —(CH₂)ₘ—R″; R″ represents a hydroxy group, substituted or unsubstituted carbonyl group, an aryl, a cycloalkyl ring, a cycloalkenyl ring, a heterocycle, or a polycycle; and m is zero or an integer ranging from 1 to 8. Where X is oxygen and R is defines as above, the moiety is also referred to as a carboxyl group. When X is oxygen and R is hydrogen, the formula represents a ‘carboxylic acid.’ Where X is oxygen and R′ is hydrogen, the formula represents a ‘formate.’ In general, where the oxygen atom of the above formula is replaced by a sulfur, the formula represents a ‘thiocarbonyl’ group. Where X is sulfur and R or R′ is not hydrogen, the formula represents a ‘thioester.’ Where X is sulfur and R is hydrogen, the formula represents a ‘thiocarboxylic acid.’ Where X is sulfur and R′ is hydrogen, the formula represents a ‘thioformate.’ Where X is a bond and R is not hydrogen, the above formula represents a ‘ketone.’ Where X is a bond and R is hydrogen, the above formula represents an ‘aldehyde.’

“Heteroalkyl,” as used herein, refers to straight or branched chain, or cyclic carbon-containing radicals, or combinations thereof, containing at least one heteroatom. Suitable heteroatoms include, but are not limited to, O, N, Si, P and S, wherein the nitrogen, phosphorous and sulfur atoms are optionally oxidized, and the nitrogen heteroatom is optionally quaternized.

Examples of saturated hydrocarbon radicals include, but are not limited to, methyl, ethyl, n-propyl, isopropyl, n-butyl, t-butyl, isobutyl, sec-butyl, cyclohexyl, (cyclohexyl)methyl, cyclopropylmethyl, and homologs and isomers of, for example, n-pentyl, n-hexyl, n-heptyl, n-octyl. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, and 3-butynyl.

“Alkoxy,” “alkylamino,” and “alkylthio” are used herein in their conventional sense, and refer to those alkyl groups attached to the remainder of the molecule via an oxygen atom, an amino group, or a sulfur atom, respectively.

“Alkylaryl,” as used herein, refers to an alkyl group substituted with an aryl group (e.g., an aromatic or hetero aromatic group).

“Heterocycle” or “heterocyclic,” as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, C₁-C₁₀) alkyl, phenyl or benzyl, and optionally containing 1-3 double bonds and optionally substituted with one or more substituents. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Heterocyclic groups can optionally be substituted with one or more substituents as defined above for alkyl and aryl.

We and others have demonstrated that poor calcium cross-linking directly caused by high DS causes loss of gel stiffness, migration of implants away from desired injection sites, and enhanced calcium leaching, leading to an increased foreign body response to the gel. One approach to loss of calcium cross-linking at high DS is to use alternative cross-linkers, but this has several drawbacks. The addition of new chemical cross-linkers add unnecessary complication to the regulatory pathway for clinical use and can have unexpected physiological toxicity. Additionally, as alternative cross-links are often covalent, these cross-linkers eliminate two advantages of using alginate in the first place—alginate's ability to self-heal and its shear-thinning characteristic.

Since the carboxyl groups in alginate strands are required for both calcium cross-linking and for carbodiimide coupling, we hypothesized that the depletion of the carboxyl groups during EDC coupling was responsible for the observed loss of calcium cross-linking and further increasing the DS on alginate worsens this affect. This is unfortunate as for many applications, including in refillable drug delivery depots, extremely high DS would be beneficial for hydrogel function.

To overcome the challenge of achieving high DS modification without sacrificing calcium cross-linking, we report a new strategy that uses modifications that restore carboxyl groups on the alginate. We propose that the groups that are coupled to alginate carry their own carboxyl groups so that carboxyl groups are replaced at every modified spot. In this report we demonstrate that alginate gels conjugated to azide groups that restore the carboxyl groups (restorative modifications) provide much improved calcium cross-linking and gelation properties as compared to the same degree of substitution of azide groups that deplete the carboxyl groups (depletive modifications). In addition, alginates with restored carboxyl groups have improved retention and drug capture at injected sites. Taken together, we believe that restorative modifications are a promising approach to highly modified calcium cross-linked alginate hydrogels.

Accordingly, in one aspect disclosed herein are substituted alginate strands comprising alginate strand coupled to an functional moiety (such as, for example, azide) via a linker with a nucleophilic terminus (such as, for example, carbamic acid, carbamate ester, glycine, arginine, or lysine), wherein the linker comprises a nucleophilic terminus and a carboxyl group of the nucleophilic terminus; and wherein the nucleophilic terminus is coupled to a carboxyl group on the alginate strand. In some aspects, the substituted alginate strands can form polymer strands.

Alginate polysaccharides are polyelectrolyte systems which have a strong affinity for divalent cations (e.g., Ca⁺², Mg⁺², Ba⁺²) and form stable hydrogels when exposed to these molecules. See Martinsen A., et al., Biotech. & Bioeng., 33 (1989) 79-89.) For example, calcium cross-linked alginate hydrogels are useful for the methods described herein. For example, the polymers, e.g., alginates, of the hydrogel are 0-100% crosslinked, e.g., at least 1%, 5%, 10%, 20%, 30%, 40%, 50%, 60%, 70%, 80%, 90%, or more, crosslinked. In other embodiments, the polymers, e.g., alginates, of the hydrogel are not crosslinked. In some examples, the polymers, e.g., alginates, of the hydrogel contain less than 50%, e.g., less than 50%, 40%, 30%, 20%, 10%, 50%, 2%, 1%, or less, crosslinking. Accordingly, also disclosed herein are hydrogel matrixes or scaffolds comprising polymer strands of the substituted alginate strand disclosed herein, wherein the polymer strands are crosslinked to other alginate polymer stands via calcium crosslinking.

Alginate may be chemically modified to yield new properties. For example, alginate may be oxidized to increase the rate of biodegradation. Alternatively, alginate may be reduced for improved biocompatibility. Alginate can also be chemically modified to change their crosslinking behavior. For instance, alginate can be modified with bioorthogonal click groups to allow click crosslinking. In another example, alginate can be modified with acrylic groups to allow radical polymerization crosslinking. As another example, alginates can be modified with host-guest chemistries to allow host-guest crosslinking.

Coupling reactions can be used to covalently attach bioactive epitopes, such as the cell adhesion sequence RGD to the polymer backbone. Chemical functionalization with small molecules regulates immune and foreign body response, functionalization with peptides mediates cellular and tissue responses, and modification with reactive chemical groups enables new modes of drug delivery. Alginate polymers conjugated to bioorthogonal “click” chemical motifs (as functional moieties) enhance cross-linking and expedite polymer modification. Additionally, alginates modified with click motifs have been used as targetable drug depots, capable of repeatedly capturing and releasing drugs.

Click chemistry refers to a class chemical reaction between two click groups that exhibit good yields, wide functional group tolerance, and are highly selective even in the presence of a complex mixture of biological molecules. These characteristics allow the click reactions to proceed even in vivo. Example click motif pairs used as the first click motif and the second click motif include, but not limited to, azide with phosphine; azide with cyclooctyne; nitrone with cyclooctyne; nitrile oxide with norbomene; oxanorbornadiene with azide; trans-cyclooctene with s-tetrazine; quadricyclane with bis(dithiobenzil)nickel(II).

In some embodiments, the second click motif comprises an alkene, e.g., a cyclooctene, e.g., a transcyclooctene (TCO) or norbornene (NOR), and the first click motif comprises a tetrazine (Tz). In other embodiments, the second click motif comprises an alkyne, e.g., a cyclooctyne such as dibenzocyclooctyne (DBCO), and the first click motif comprises an azide (Az). In some embodiments, the second click motif comprises a Tz, and the first click motif comprises an alkene such as transcyclooctene (TCO) or norbomene (NOR). Alternatively or in addition, the first click motif comprises an Az, and the second click motif comprises a cyclooctyne such as dibenzocyclooctyne (DBCO). TCO reacts specifically in a click chemistry reaction with a tetrazine (Tz) moiety. DBCO reacts specifically in a click chemistry reaction with an azide (Az) moiety. Norbomene reacts specifically in a click chemistry reaction with a tetrazine (Tz) moiety.

Exemplary click chemistry reactions (and by extension click motifs) are shown below. For example, copper(I)-catalyzed Azide-Alkyne Cycloaddition (CuAAC) comprises using a Copper (Cu) catalyst at room temperature. The Azide-Alkyne Cycloaddition is a 1,3-dipolar cycloaddition between an azide and a terminal or internal alkyne to give a 1,2,3-triazole.

Another example of click chemistry includes Staudinger ligation, which is a reaction that is based on the classic Staudinger reaction of azides with triarylphosphines. It launched the field of bioorthogonal chemistry as the first reaction with completely abiotic functional. The azide acts as a soft electrophile that prefers soft nucleophiles such as phosphines. This is in contrast to most biological nucleophiles which are typically hard nucleophiles. The reaction proceeds selectively under water-tolerant conditions to produce a stable product. Phosphines are completely absent from living systems and do not reduce disulfide bonds despite mild reduction potential. Azides had been shown to be biocompatible in FDA-approved drugs such as azidothymidine and through other uses as cross linkers. Additionally, their small size allows them to be easily incorporated into biomolecules through cellular metabolic pathways.

Copper-free click chemistry is a bioorthogonal reaction first developed by Carolyn Bertozzi as an activated variant of an azide alkyne cycloaddition. Unlike CuAAC, Cu-free click chemistry has been modified to be bioorthogonal by eliminating a cytotoxic copper catalyst, allowing reaction to proceed quickly and without live cell toxicity. Instead of copper, the reaction is a strain-promoted alkyne-azide cycloaddition (SPAAC). It was developed as a faster alternative to the Staudinger ligation, with the first generations reacting over sixty times faster. The incredible bioorthogonality of the reaction has allowed the Cu-free click reaction to be applied within cultured cells, live zebrafish, and mice. Cyclooctynes were selected as the smallest stable alkyne ring which increases reactivity through ring strain which has calculated to be 19.9 kcal/mol.

Copper-free click chemistry also includes nitrone dipole cycloaddition. Copper-free click chemistry has been adapted to use nitrones as the 1,3-dipole rather than azides and has been used in the modification of peptides.

This cycloaddition between a nitrone and a cyclooctyne forms N-alkylated isoxazolines. The reaction rate is enhanced by water and is extremely fast with second order rate constants ranging from 12 to 32 M⁻¹·s⁻¹, depending on the substitution of the nitrone. Although the reaction is extremely fast, incorporating the nitrone into biomolecules through metabolic labeling has only been achieved through post-translational peptide modification.

Another example of click chemistry includes norbomene cycloaddition. 1,3 dipolar cycloadditions have been developed as a bioorthogonal reaction using a nitrile oxide as a 1,3-dipole and a norbornene as a dipolarophile. Its primary use has been in labeling DNA and RNA in automated oligonucleotide synthesizers.

Norbornenes were selected as dipolarophiles due to their balance between strain-promoted reactivity and stability. The drawbacks of this reaction include the cross-reactivity of the nitrile oxide due to strong electrophilicity and slow reaction kinetics.

Another example of click chemistry includes oxanorbornadiene cycloaddition. The oxanorbornadiene cycloaddition is a 1,3-dipolar cycloaddition followed by a retro-Diels Alder reaction to generate a triazole-linked conjugate with the elimination of a furan molecule. This reaction is useful in peptide labeling experiments, and it has also been used in the generation of SPECT imaging compounds.

Ring strain and electron deficiency in the oxanorbornadiene increase reactivity towards the cycloaddition rate-limiting step. The retro-Diels Alder reaction occurs quickly afterwards to form the stable 1,2,3 triazole. Limitations of this reaction include poor tolerance for substituents which may change electronics of the oxanorbornadiene and low rates (second order rate constants on the order of 10⁻⁴).

Another example of click chemistry includes tetrazine ligation. The tetrazine ligation is the reaction of a trans-cyclooctene and an s-tetrazine in an inverse-demand Diels Alder reaction followed by a retro-Diels Alder reaction to eliminate nitrogen gas. The reaction is extremely rapid with a second order rate constant of 2000 M⁻¹-s⁻¹(in 9:1 methanol/water) allowing modifications of biomolecules at extremely low concentrations.

The highly strained trans-cyclooctene is used as a reactive dienophile. The diene is a 3,6-diaryl-s-tetrazine which has been substituted in order to resist immediate reaction with water. The reaction proceeds through an initial cycloaddition followed by a reverse Diels Alder to eliminate N2 and prevent reversibility of the reaction.

Not only is the reaction tolerant of water, but it has been found that the rate increases in aqueous media. Reactions have also been performed using norbornenes as dienophiles at second order rates on the order of 1 M⁻¹·s⁻¹ in aqueous media. The reaction has been applied in labeling live cells and polymer coupling.

Another example of click chemistry includes is [4+1] cycloaddition. This isocyanide click reaction is a [4+1] cycloaddition followed by a retro-Diels Alder elimination of N2.

The reaction proceeds with an initial [4+1] cycloaddition followed by a reversion to eliminate a thermodynamic sink and prevent reversibility. This product is stable if a tertiary amine or isocyanopropanoate is used. If a secondary or primary isocyanide is used, the produce will form an imine which is quickly hydrolyzed.

Isocyanide is a favored chemical reporter due to its small size, stability, non-toxicity, and absence in mammalian systems. However, the reaction is slow, with second order rate constants on the order of 10⁻² M⁻¹·s⁻¹.

Another example of click chemistry includes quadricyclane ligation. The quadricyclane ligation utilizes a highly strained quadricyclane to undergo [2+2+2] cycloaddition with 7 systems.

Quadricyclane is abiotic, unreactive with biomolecules (due to complete saturation), relatively small, and highly strained (^{˜}80 kcal/mol). However, it is highly stable at room temperature and in aqueous conditions at physiological pH. It is selectively able to react with electron-poor π systems but not simple alkenes, alkynes, or cyclooctynes.

Bis(dithiobenzil)nickel(II) was chosen as a reaction partner out of a candidate screen based on reactivity. To prevent light-induced reversion to norbomadiene, diethyldithiocarbamate is added to chelate the nickel in the product.

These reactions are enhanced by aqueous conditions with a second order rate constant of 0.25 M⁻¹·s⁻¹. Of particular interest is that it has been proven to be bioorthogonal to both oxime formation and copper-free click chemistry.

The exemplary click chemistry reactions have high specificity, efficient kinetics, and occur in vivo under physiological conditions. See, e.g., Baskin et al. Proc. Natd. Acad. Sci. USA 104(2007):16793; Oneto et al. Acta biomaterilia (2014); Neves et al. Bioconjugate chemistry 24(2013):934; Koo et al. Angewandte Chemie 51(2012):11836; and Rossin et al. Angewandte Chemie 49(2010):3375. For a review of a wide variety of click chemistry reactions and their methodologies, see e.g., Nwe K and Brechbiel M W, 2009 Cancer Biotherapy and Radiopharmaceuticals, 24(3): 289-302; Kolb H C et al., 2001 Angew. Chem. Int. Ed. 40: 2004-2021. The entire contents of each of the foregoing references are incorporated herein by reference.

Exemplary click motif pairs are shown in the table below.

| Functional | | | |
|---|---|---|---|
| group/Click | Paired | | Reaction type |
| Motif | with | Functional group/Click Motif | (Reference) |
| azide | | Phosphine | Staudinger ligation |
| | | | (Saxon et al. Science |
| | | | 287(2000):2007-10) |
| azide | | Cyclooctyne, e.g., dibenzocyclooctyne, one of | Copper-free click |
| | | the cyclooctynes shown below, or other similar | chemistry (Jewett et al. |
| | | cyclooctynes: | J. Am. Chem. Soc. |
| | | | 132.11(2010):3688-90; |
| | | 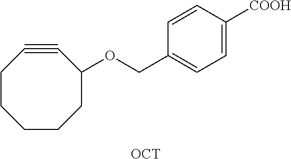 [SMILES: O=C(O)c1ccc(COC2C#CCCCCC2)cc1 ; "OCT"] | Sletten et al. Organic Letters 10.14 (2008):3097-9; Lutz. Angew. Chem., Int. Ed 47.12(2008):2182) |
| | | 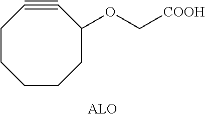 [SMILES: O=C(O)COC1C#CCCCCC1] | |
| | | 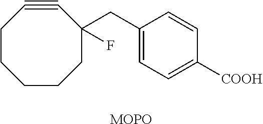 | |
| | | 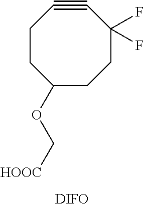 | |
| | | 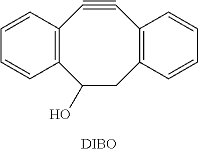 | |
| | | 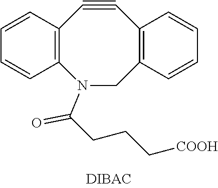 [SMILES: O=C(O)CCCC(=O)N1Cc2ccccc2C#Cc2ccccc21] | |
| | | 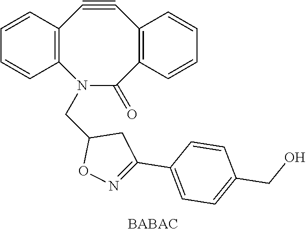 [SMILES: O=C1c2ccccc2C#Cc2ccccc2N1CC1CC(c2ccc(CO)cc2)=NO1] | |
| | | 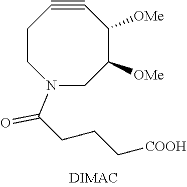 [SMILES: CO[C@H]1C#CCCN(C(=O)CCCC(=O)O)C[C@@H]1OC] | |
| nitrone | | Cyclooctyne | Nitrone Dipole |
| | | | Cycloaddition (Ning et |
| | | | al. Angew. Chem., Int. |
| | | | Ed 49.17 (2010):3065) |
| Nitrile oxide | | Norbornene | Norbornene |
| | | | Cycloaddition |
| | | | (Gutsmiedl et al. |
| | | | Organic Letters |
| | | | 11.11(2009):2405-8) |
| oxanorbornadiene | | Azide | Oxanorbornadiene |
| | | | Cycloaddition (Van |
| | | | Berkel et al. |
| | | | ChemBioChem |
| | | | 8.13(2007):1504-8) |
| Trans- | | s-tetrazine | Tetrazine ligation |
| cyclooctene, | | | (Hansell et al. J. Am. |
| norbornene, or | | | Chem. Soc. |
| other alkene | | | 133.35(2011):13828-31) |
| nitrile | | 1,2,4,5-tetrazine | [4+1] cycloaddition |
| | | | (Stackman et al. |
| | | | Organic and Biomol. |
| | | | Chem. 9.21(2011):7303) |
| quadricyclane | | Bis(dithiobenzil)nickel(II) | Quadricyclane Ligation |
| | | | (Sletten et al. J. Am. |
| | | | Chem. Soc. |
| | | | 133.44(2011): 17570-3) |
| Ketone or | | Hydrazines, hydrazones, oximes, amines, | Non-aldol carbonyl |
| aldehyde | | ureas, thioureas, etc. | chemistry |
| | | | (Khomyakova EA, et al. |
| | | | Nucleosides Nucleotides |
| | | | Nucleic Acids. 30(7-8) |
| | | | (2011) 577-84 |
| Thiol | | Maleimide | Michael addition |
| | | | (Zhou et al. Bioconjug |
| | | | Chem 2007 18(2):323- |
| | | | 32.) |
| Dienes | | Dienophiles | Diels Alder (Rossin et |
| | | | al. Nucl Med. (2013) |
| | | | 54(11): 1989-95) |
| Tetrazine | | norbornene, propene, trans-cyclooctene, other | |
| | | strained alkenes. | |

Other suitable include the motifs can be found, for example, in Patterson, D. M., et al. “Finding the Right (Bioorthogonal) Chemistry,” ACS Chem. Biol., 2014, 9(3): 592-605; Akgun, B., et al. “Synergic “Click” Boronate/Thiosemicarbazone System for Fast and Irreversible Bioorthogonal Conjugation in Live Cells,” J. Am. Chem. Soc., 2017, 139(40): 14285-14291; and Akgun, B. and Hall, D. G. “Fast and Tight Boronate Formation for Click Bioorthogonal Conjugation,” Angew. Chem., Int. Ed. 2016, 55(12): 3909-3913, each of which is hereby incorporated by reference in its entirety

Alginate polymers are formed into a variety of hydrogel types. Alginate hydrogels can be formed from low molecular weight (MW) alginate or from high MW alginate. Differences in hydrogel formulation control the kinetics of hydrogel degradation. Release rates of pharmaceutical compositions, e.g., small molecules, morphogens, or other bioactive substances, from alginate hydrogels is controlled by hydrogel formulation to present the pharmaceutical compositions in a spatially and temporally controlled manner. This controlled release eliminates systemic side effects and the need for multiple injections.

Mannuronate and guluronate monomers contain a carboxylic acid moiety which can serve as a point of covalent modification. In preferred embodiments, the carboxylic acid moiety present on one or more mannuronate and/or guluronate residues can be covalently modified via amidation. However, as noted herein, amidation of alginate typically causes loss of carboxyl residues which in turn results in destructive effects on the ability of alginate polymers to crosslink via Calcium crosslinking. The result is a loss of many of the advantageous properties of the alginate polymers. Accordingly, disclosed herein are substituted alginate strands that do not suffer from these problems and methods for achieving said modified alginate strands. In one aspect, disclosed herein are methods of coupling an alginate strand to a functional moiety (e.g., a click motif discussed above, such as, for example, an azide) via carbodiimide coupling said method comprising conjugating the functional moiety to a linker comprising an nucleophilic terminus and a carboxyl group of the nucleophilic terminus of the linker (such as, for example, carbamic acid, carbamate ester, glycine, arginine, or lysine); wherein the functional moiety is chemically coupled to the linker at the opposing end to the nucleophilic terminus; and coupling the nucleophilic terminus of the linker to the alginate strand via carbodiimide coupling; wherein the modification allows for synthesis of highly substituted alginate; wherein the substitution does not disrupt the integrity of the gel.

To prevent the amino terminal end of the linker binding to the carboxyl group of the linker prior to amidation to the alginate strand, the carboxyl group on the linker can be blocked with a protecting group. Any protecting group known and used in the art can be used for this purpose, including, but not limited to methyl, ethyl, benzyl, benzyloxycarbonyl, s-Butyl, 2-Alkyl-1,3-oxazoline, OBO, silyl, photo-sensitive group propyl, tert-butyl, and NVOC.

Also disclosed herein are methods of coupling an alginate strand to a functional moiety, wherein the nucleophilic terminus of the linker comprises a protecting group (such as, for example, tert-butyloxycarbonyl, α-boc, p-methoxybenzyl carbonyl, carbobenzyloxy, acetyl, benzoyl, benzyl, carbamate, p-methoyxybenzyl, 3,4-dimethoxybenyl, p-methoxyphyl, trichloroethyl chloroformate, or tosyl); and wherein the nucleophilic terminus is deprotected prior to being coupled to the alginate strand.

Also provided here are modified alginates. The modified alginates include alginate monomers that have been covalently modified to facilitate crosslinking while without sacrificing calcium cross-linking. The modified alginates can comprise one or more covalently modified monomers defined by Formula I below

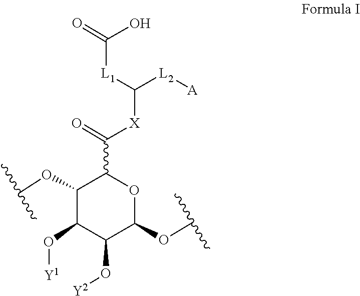

wherein:
X is O, S, or NR₃;
R₃ is hydrogen, alkyl, alkenyl, alkynyl, aryl, heteroaryl, cycloalkyl, or heterocycloalkyl;
L₁ and L₂ are each independently absent or represent a linking group;
A represents a functional moiety; and
Y₁ and Y₂ independently are hydrogen or —PO(OR)₂, or Y₂ is absent, and Y₁, together with the two oxygen atoms to which Y₁ and Y₂ are attached form a cyclic structure as shown below

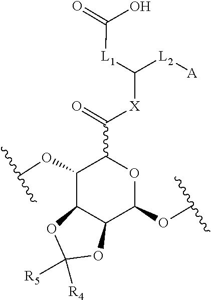

wherein
wherein R₄ and R₅ are, independently, hydrogen, alkyl, alkenyl, alkynyl, aryl, heteroaryl, cycloalkyl, heterocycloalkyl, alkoxy, aroxy, alkylthio, carbonyl, carboxyl, amino, or amido; or R₄ and R₅, together with the carbon atom to which they are attached, form a 3- to 8-membered unsubstituted or substituted carbocyclic or heterocyclic ring.

In certain embodiments, Y₁ and Y₂ are both H.

In certain embodiments, X is NH.

In some embodiments, A can comprise a click motif. Examples of suitable click motifs are described above. For example, in some embodiments, A can comprise an azide, a phosphine, a cyclooctene (e.g., a transcyclooctene (TCO)), a norbornene (NOR), a tetrazine (Tz), an alkyne, a cyclooctyne such as dibenzocyclooctyne (DBCO), or a quadricyclane. In certain embodiments, the functional moiety comprises an active agent, as described below.

In some embodiments, both L₁ and L₂ are present. In some embodiments, L₁ is absent and L₂ is present. In some embodiments, L₁ is present and L₂ is absent. In some embodiments, both L₁ and L₂ are absent.

When present, the linking group can be any suitable group or moiety which is at minimum bivalent, and connects the two radical moieties to which the linking group is attached in the monomers of Formula I. The linking group can be composed of any assembly of atoms, including oligomeric and polymeric chains. In some cases, the total number of atoms in the linking group can be from 3 to 200 atoms (e.g., from 3 to 150 atoms, from 3 to 100 atoms, from 3 and 50 atoms, from 3 to 25 atoms, from 3 to 15 atoms, or from 3 to 10 atoms).

In some embodiments, the linking group can be, for example, an alkyl, alkoxy, alkylaryl, alkylheteroaryl, alkylcycloalkyl, alkylheterocycloalkyl, alkylthio, alkylsulfinyl, alkylsulfonyl, alkylamino, dialkylamino, alkylcarbonyl, alkoxycarbonyl, alkylaminocarbonyl, dialkylaminocarbonyl, or polyamino group. In some embodiments, the linking group can comprises one of the groups above joined to one or both of the moieties to which it is attached by a functional group. Examples of suitable functional groups include, for example, secondary amides (—CONH—), tertiary amides (—CONR—), secondary carbamates (—OCONH—; —NHCOO—), tertiary carbamates (—OCONR—; —NRCOO—), ureas (—NHCONH—; —NRCONH—; —NHCONR—, or —NRCONR—), carbinols (—CHOH—, —CROH—), ethers (—O—), and esters (—COO—, —CH₂O₂C—, CHRO₂C—), wherein R is an alkyl group, an aryl group, or a heterocyclic group. For example, in some embodiments, the linking group can comprise an alkyl group (e.g., a C₁-C₁₂ alkyl group, a C₁-C₈ alkyl group, or a C₁-C₆ alkyl group) bound to one or both of the moieties to which it is attached via an ester (—COO—, —CH₂O₂C—, CHRO₂C—), a secondary amide (—CONH—), or a tertiary amide (—CONR—), wherein R is an alkyl group, an aryl group, or a heterocyclic group. In certain embodiments, the linking group can be chosen from one of the following:

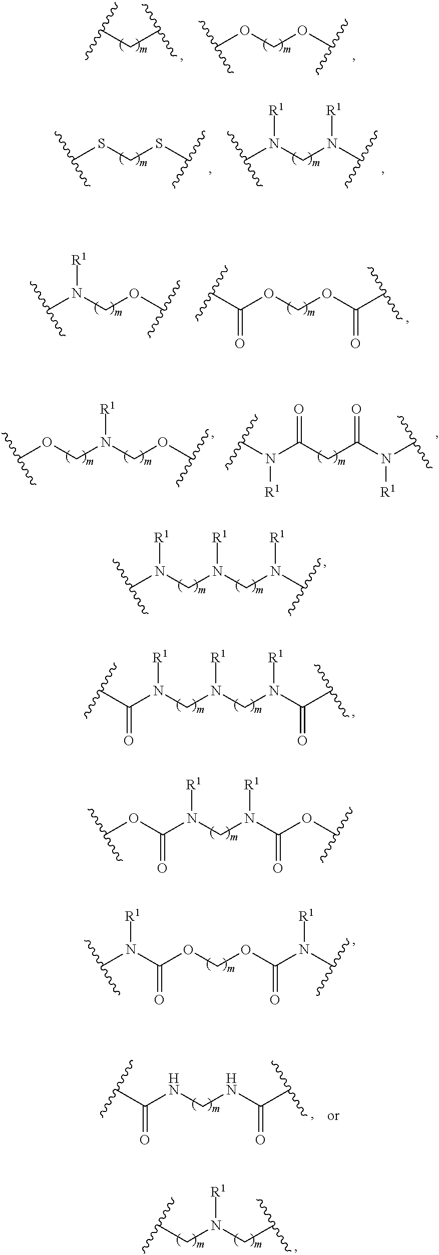

where m is an integer from 1 to 12 and R₁ is, independently for each occurrence, hydrogen, an alkyl group, an aryl group, or a heterocyclic group.

If desired, the linker can serve to modify the solubility of the compounds described herein. In some embodiments, the linker is hydrophilic. In some embodiments, the linker can be an alkyl group, an alkylaryl group, an oligo- or polyalkylene oxide chain (e.g., an oligo- or polyethylene glycol chain), or an oligo- or poly(amino acid) chain.

Modified alginate polymers can be of any desired molecular weight. The weight average molecular weight of the alginates is preferably between 1,000 and 1,000,000 Daltons, more preferably between 10,000 and 500,000 Daltons as determined by gel permeation chromatography.

Modified alginate polymers can contain any ratio of mannuronate monomers, guluronate monomers, and covalently modified monomers. In some embodiments, greater than 2.5%, 5%, 7.5%, 10%, 12%, 14%, 15%, 16%, 18%, 20%, 22%, 24%, 25%, 26%, 28%, 30%, 32.5%, 35%, 37.5%, 40%, 45%, 50%, 55%, or 60% of the monomers in the modified alginate polymer are covalently modified monomers. Preferably greater than 10%, more preferably greater than 20%, and most preferably greater than 30% of the monomers in the modified alginate polymer are covalently modified monomers.

### Active Agents

The term “Active Agent”, as used herein, refers to a physiologically or pharmacologically active substance that acts locally and/or systemically in the body. An active agent is a substance that is administered to a patient for the treatment (e.g., therapeutic agent), prevention (e.g., prophylactic agent), or diagnosis (e.g., diagnostic agent) of a disease or disorder.

The active agent can be a small molecule, or a biologic. A biologic is a medicinal product manufactured in, extracted from, or semi-synthesized from biological sources which is different from chemically synthesized pharmaceuticals. In some embodiments, biologics used as the active agent can include, for example, antibodies, blood components, allergenics, gene therapies, and recombinant therapeutic proteins. Biologics can comprise, for example, sugars, proteins, or nucleic acids, and they can be isolated from natural sources such as human, animal, or microorganism.

In some embodiments, the active agent can comprise an anti-cancer drug, a drug that promotes wound healing, a drug that treats or prevents infection, or a drug that promotes vascularization. For example, the active agent can comprise an anti-cancer drug, such as a chemotherapeutic or a cancer vaccine. The anti-cancer drug can include a small molecule, a peptide or polypeptide, a protein or fragment thereof (e.g., an antibody or fragment thereof), or a nucleic acid.

Exemplary anti-cancer drugs can include, but are not limited to, Abiraterone Acetate, Abitrexate (Methotrexate), Abraxane (Paclitaxel Albumin-stabilized Nanoparticle Formulation), ABVD, ABVE, ABVE-PC, AC, AC-T, Adcetris (Brentuximab Vedotin), ADE, Ado-Trastuzumab Emtansine, Adriamycin (Doxorubicin Hydrochloride), Adrucil (Fluorouracil), Afatinib Dimaleate, Afinitor (Everolimus), Aldara (Imiquimod), Aldesleukin, Alemtuzumab, Alimta (Pemetrexed Disodium), Aloxi (Palonosetron Hydrochloride), Ambochlorin (Chlorambucil), Aminolevulinic Acid, Anastrozole, Aprepitant, Aredia (Pamidronate Disodium), Arimidex (Anastrozole), Aromasin (Exemestane), Arranon (Nelarabine), Arsenic Trioxide, Arzerra (Ofatumumab), Asparaginase Erwinia chrysanthemi, Avastin (Bevacizumab), Axitinib, Azacitidine, BEACOPP, Bendamustine Hydrochloride, BEP, Bevacizumab, Bexarotene, Bexxar (Tositumomab and I 131 Iodine Tositumomab), Bicalutamide, Bleomycin, Bortezomib, Bosulif (Bosutinib), Bosutinib, Brentuximab Vedotin, Busulfan, Busulfex (Busulfan), Cabazitaxel, Cabozantinib-S-Malate, CAF, Campath (Alemtuzumab), Camptosar (Irinotecan Hydrochloride), Capecitabine, CAPDX, Carboplatin, Carboplatin-Taxol, Carfilzomib, Casodex (Bicalutamide), CeeNU (Lomustine), Cerubidine (Daunorubicin Hydrochloride), Cervarix (Recombinant HPV Bivalent Vaccine), Cetuximab, Chlorambucil, Chlorambucil-Prednisone, CHOP, Cisplatin, Clafen (Cyclophosphamide), Clofarabine, Clofarex (Clofarabine), Clolar (Clofarabine), CMF, Cometriq (Cabozantinib-S-Malate), COPP, COPP-ABV, Cosmegen (Dactinomycin), Crizotinib, CVP, Cyclophosphamide, Cyfos (Ifosfamide), Cytarabine, Cytarabine (Liposomal), Cytosar-U (Cytarabine), Cytoxan (Cyclophosphamide), Dabrafenib, Dacarbazine, Dacogen (Decitabine), Dactinomycin, Dasatinib, Daunorubicin Hydrochloride, Decitabine, Degarelix, Denileukin Diftitox, Denosumab, DepoCyt (Liposomal Cytarabine), DepoFoam (Liposomal Cytarabine), Dexrazoxane Hydrochloride, Docetaxel, Doxil (Doxorubicin Hydrochloride Liposome), Doxorubicin Hydrochloride, Doxorubicin Hydrochloride Liposome, Dox-SL (Doxorubicin Hydrochloride Liposome), DTIC-Dome (Dacarbazine), Efudex (Fluorouracil), Elitek (Rasburicase), Ellence (Epirubicin Hydrochloride), Eloxatin (Oxaliplatin), Eltrombopag Olamine, Emend (Aprepitant), Enzalutamide, Epirubicin Hydrochloride, EPOCH, Erbitux (Cetuximab), Eribulin Mesylate, Erivedge (Vismodegib), Erlotinib Hydrochloride, Erwinaze (Asparaginase Erwinia chrysanthemi), Etopophos (Etoposide Phosphate), Etoposide, Etoposide Phosphate, Evacet (Doxorubicin Hydrochloride Liposome), Everolimus, Evista (Raloxifene Hydrochloride), Exemestane, Fareston (Toremifene), Faslodex (Fulvestrant), FEC, Femara (Letrozole), Filgrastim, Fludara (Fludarabine Phosphate), Fludarabine Phosphate, Fluoroplex (Fluorouracil), Fluorouracil, Folex (Methotrexate), Folex PFS (Methotrexate), Folfiri, Folfiri-Bevacizumab, Folfiri-Cetuximab, Folfirinox, Folfox, Folotyn (Pralatrexate), FU-LV, Fulvestrant, Gardasil (Recombinant HPV Quadrivalent Vaccine), Gazyva (Obinutuzumab), Gefitinib, Gemcitabine Hydrochloride, Gemcitabine-Cisplatin, Gemcitabine-Oxaliplatin, Gemtuzumab Ozogamicin, Gemzar (Gemcitabine Hydrochloride), Gilotrif (Afatinib Dimaleate), Gleevec (Imatinib Mesylate), Glucarpidase, Goserelin Acetate, Halaven (Eribulin Mesylate), Herceptin (Trastuzumab), HPV Bivalent Vaccine (Recombinant), HPV Quadrivalent Vaccine (Recombinant), Hycamtin (Topotecan Hydrochloride), Hyper-CVAD, Ibritumomab Tiuxetan, Ibrutinib, ICE, Iclusig (Ponatinib Hydrochloride), Ifex (Ifosfamide), Ifosfamide, Ifosfamidum (Ifosfamide), Imatinib Mesylate, Imbruvica (Ibrutinib), Imiquimod, Inlyta (Axitinib), Intron A (Recombinant Interferon Alfa-2b), Iodine 131 Tositumomab and Tositumomab, Ipilimumab, Iressa (Gefitinib), Irinotecan Hydrochloride, Istodax (Romidepsin), Ixabepilone, Ixempra (Ixabepilone), Jakafi (Ruxolitinib Phosphate), Jevtana (Cabazitaxel), Kadcyla (Ado-Trastuzumab Emtansine), Keoxifene (Raloxifene Hydrochloride), Kepivance (Palifermin), Kyprolis (Carfilzomib), Lapatinib Ditosylate, Lenalidomide, Letrozole, Leucovorin Calcium, Leukeran (Chlorambucil), Leuprolide Acetate, Levulan (Aminolevulinic Acid), Linfolizin (Chlorambucil), LipoDox (Doxorubicin Hydrochloride Liposome), Liposomal Cytarabine, Lomustine, Lupron (Leuprolide Acetate), Lupron Depot (Leuprolide Acetate), Lupron Depot-Ped (Leuprolide Acetate), Lupron Depot-3 Month (Leuprolide Acetate), Lupron Depot-4 Month (Leuprolide Acetate), Marqibo (Vincristine Sulfate Liposome), Matulane (Procarbazine Hydrochloride), Mechlorethamine Hydrochloride, Megace (Megestrol Acetate), Megestrol Acetate, Mekinist (Trametinib), Mercaptopurine, Mesna, Mesnex (Mesna), Methazolastone (Temozolomide), Methotrexate, Methotrexate LPF (Methotrexate), Mexate (Methotrexate), Mexate-AQ (Methotrexate), Mitomycin C, Mitozytrex (Mitomycin C), MOPP, Mozobil (Plerixafor), Mustargen (Mechlorethamine Hydrochloride), Mutamycin (Mitomycin C), Myleran (Busulfan), Mylosar (Azacitidine), Mylotarg (Gemtuzumab Ozogamicin), Nanoparticle Paclitaxel (Paclitaxel Albumin-stabilized Nanoparticle Formulation), Navelbine (Vinorelbine Tartrate), Nelarabine, Neosar (Cyclophosphamide), Neupogen (Filgrastim), Nexavar (Sorafenib Tosylate), Nilotinib, Nolvadex (Tamoxifen Citrate), Nplate (Romiplostim), Obinutuzumab, Ofatumumab, Omacetaxine Mepesuccinate, Oncaspar (Pegaspargase), Ontak (Denileukin Diftitox), OEPA, OPPA, Oxaliplatin, Paclitaxel, Paclitaxel Albumin-stabilized Nanoparticle Formulation, Palifermin, Palonosetron Hydrochloride, Pamidronate Disodium, Panitumumab, Paraplat (Carboplatin), Paraplatin (Carboplatin), Pazopanib Hydrochloride, Pegaspargase, Peginterferon Alfa-2b, PEG-Intron (Peginterferon Alfa-2b), Pemetrexed Disodium, Perjeta (Pertuzumab), Pertuzumab, Platinol (Cisplatin), Platinol-AQ (Cisplatin), Plerixafor, Pomalidomide, Pomalyst (Pomalidomide), Ponatinib Hydrochloride, Pralatrexate, Prednisone, Procarbazine Hydrochloride, Proleukin (Aldesleukin), Prolia (Denosumab), Promacta (Eltrombopag Olamine), Provenge (Sipuleucel-T), Purinethol (Mercaptopurine), Radium 223 Dichloride, Raloxifene Hydrochloride, Rasburicase, R—CHOP, R—CVP, Recombinant HPV Bivalent Vaccine, Recombinant HPV Quadrivalent Vaccine, Recombinant Interferon Alfa-2b, Regorafenib, Revlimid (Lenalidomide), Rheumatrex (Methotrexate), Rituxan (Rituximab), Rituximab, Romidepsin, Romiplostim, Rubidomycin (Daunorubicin Hydrochloride), Ruxolitinib Phosphate, Sclerosol Intrapleural Aerosol (Talc), Sipuleucel-T, Sorafenib Tosylate, Sprycel (Dasatinib), Stanford V, Sterile Talc Powder (Talc), Steritalc (Talc), Stivarga (Regorafenib), Sunitinib Malate, Sutent (Sunitinib Malate), Sylatron (Peginterferon Alfa-2b), Synovir (Thalidomide), Synribo (Omacetaxine Mepesuccinate), Tafinlar (Dabrafenib), Talc, Tamoxifen Citrate, Tarabine PFS (Cytarabine), Tarceva (Erlotinib Hydrochloride), Targretin (Bexarotene), Tasigna (Nilotinib), Taxol (Paclitaxel), Taxotere (Docetaxel), Temodar (Temozolomide), Temozolomide, Temsirolimus, Thalidomide, Thalomid (Thalidomide), Toposar (Etoposide), Topotecan Hydrochloride, Toremifene, Torisel (Temsirolimus), Tositumomab and I¹³¹ Iodine Tositumomab, Totect (Dexrazoxane Hydrochloride), Trametinib, Trastuzumab, Treanda (Bendamustine Hydrochloride), Trisenox (Arsenic Trioxide), Tykerb (Lapatinib Ditosylate), Vandetanib, VAMP, Vectibix (Panitumumab), VeIP, Velban (Vinblastine Sulfate), Velcade (Bortezomib), Velsar (Vinblastine Sulfate), Vemurafenib, VePesid (Etoposide), Viadur (Leuprolide Acetate), Vidaza (Azacitidine), Vinblastine Sulfate, Vincasar PFS (Vincristine Sulfate), Vincristine Sulfate, Vincristine Sulfate Liposome, Vinorelbine Tartrate, Vismodegib, Voraxaze (Glucarpidase), Vorinostat, Votrient (Pazopanib Hydrochloride), Wellcovorin (Leucovorin Calcium), Xalkori (Crizotinib), Xeloda (Capecitabine), XELOX, Xgeva (Denosumab), Xofigo (Radium 223 Dichloride), Xtandi (Enzalutamide), Yervoy (Ipilimumab), Zaltrap (Ziv-Aflibercept), Zelboraf (Vemurafenib), Zevalin (Ibritumomab Tiuxetan), Zinecard (Dexrazoxane Hydrochloride), Ziv-Aflibercept, Zoladex (Goserelin Acetate), Zoledronic Acid, Zolinza (Vorinostat), Zometa (Zoledronic Acid), and Zytiga (Abiraterone Acetate).

In some embodiments, the active agent can comprise a drug that promotes wound healing or vascularization. In some embodiments, the active agent can comprise a drug that reduces ischemia, e.g., due to peripheral artery disease (PAD) or damaged myocardial tissues due to myocardial infarction. For example, the drug can comprise a protein or fragment thereof, e.g., a growth factor or angiogenic factor, such as vascular endothelial growth factor (VEGF), e.g., VEGFA, VEGFB, VEGFC, or VEGFD, and/or IGF, e.g., IGF-1, fibroblast growth factor (FGF), angiopoietin (ANG) (e.g., Ang1 or Ang2), matrix metalloproteinase (MMP), delta-like ligand 4 (DLL4), paclitaxel, or combinations thereof. Drugs that promote wound healing or vascularization are non-limiting, as the skilled artisan would be able to readily identify other drugs that promote wound healing or vascularization.

In some embodiments, the active agent can comprise an anti-proliferative drug, e.g., mycophenolate mofetil (MMF), azathioprine, sirolimus, tacrolimus, paclitaxel, biolimus A9, novolimus, myolimus, zotarolimus, everolimus, or tranilast. These anti-proliferative drugs are non-limiting, as the skilled artisan would be able to readily identify other anti-proliferative drugs.

In some embodiments, the active agent can comprise an anti-inflammatory drug, e.g., corticosteroid anti-inflammatory drugs (e.g., beclomethasone, beclometasone, budesonide, flunisolide, fluticasone propionate, triamcinolone, methylprednisolone, prednisolone, or prednisone); or non-steroidal anti-inflammatory drugs (NSAIDs) (e.g., acetylsalicylic acid, diflunisal, salsalate, choline magnesium trisalicylate, ibuprofen, dexibuprofen, naproxen, fenoprofen, ketoprofen, dexketoprofen, fluribiprofen, oxaprozin, loxoprofen, indomethacin, tolmetin, sulindac, etodolac, ketorolac, diclofenac, aceclofenac, nabumetone, piroxicam, meloxicam, tenoxicam, droxicam, lornoxicam, isoxicam, mefenamic acid, meclofenamic acid, flufenamic acid, tolfenamic acid, celecoxib, rofecoxib, valdecoxib, parecoxib, lumiracoxib, etoricoxib, firocoxib, nimesulide, licofelone, H-harpaide, or lysine clonixinate). These anti-inflammatory drugs are non-limiting, as the skilled artisan would be able to readily identify other anti-inflammatory drugs.

In some embodiments, the active agent can comprise a drug that prevents or reduces transplant rejection, e.g., an immunosuppressant. Exemplary immunosuppressants include calcineurin inhibitors (e.g., cyclosporine, Tacrolimus (FK506)); mammalian target of rapamycin (mTOR) inhibitors (e.g., rapamycin, also known as Sirolimus); antiproliferative agents (e.g., azathioprine, mycophenolate mofetil, mycophenolate sodium); antibodies (e.g., basiliximab, daclizumab, muromonab); corticosteroids (e.g., prednisone). These drugs that prevent or reduce transplant rejection are non-limiting, as the skilled artisan would be able to readily identify other drugs that prevent or reduce transplant rejection.

In some embodiments, the active agent can comprise an anti-thrombotic drug, e.g., an anti-platelet drug, an anticoagulant drug, or a thrombolytic drug.

Exemplary anti-platelet drugs include an irreversible cyclooxygenase inhibitor (e.g., aspirin or triflusal); an adenosine diphosphate (ADP) receptor inhibitor (e.g., ticlopidine, clopidogrel, prasugrel, or tricagrelor); a phosphodiesterase inhibitor (e.g., cilostazol); a glycoprotein IIB/IIIA inhibitor (e.g., abciximab, eptifibatide, or tirofiban); an adenosine reuptake inhibitor (e.g., dipyridamole); or a thromboxane inhibitor (e.g., thromboxane synthase inhibitor, a thromboxane receptor inhibitor, such as terutroban). These anti-platelet drugs are non-limiting, as the skilled artisan would be able to readily identify other anti-platelet drugs.

Exemplary anticoagulant drugs include coumarins (e.g., warfarin, acenocoumarol, phenprocoumon, atromentin, brodifacoum, or phenindione); heparin and derivatives thereof (e.g., heparin, low molecular weight heparin, fondaparinux, or idraparinux); factor Xa inhibitors (e.g., rivaroxaban, apixaban, edoxaban, betrixaban, darexaban, letaxaban, or eribaxaban); thrombin inhibitors (e.g., hirudin, lepirudin, bivalirudin, argatroban, or dabigatran); antithrombin protein; batroxobin; hementin; and thrombomodulin. These anticoagulant drugs are non-limiting, as the skilled artisan would be able to readily identify other anticoagulant drugs.

Exemplary thrombolytic drugs include tissue plasminogen activator (t-PA) (e.g., alteplase, reteplase, or tenecteplase); anistreplase; streptokinase; or urokinase.

In other embodiments, the active agent can comprise a drug that prevents restenosis, e.g., an anti-proliferative drug, an anti-inflammatory drug, or an anti-thrombotic drug. Exemplary anti-proliferative drugs, anti-inflammatory drugs, and anti-thrombotic drugs are described herein.

In some embodiments, the active agent can comprise a drug that treats or prevents infection, e.g., an antibiotic. Suitable antibiotics include, but are not limited to, beta-lactam antibiotics (e.g., penicillins, cephalosporins, carbapenems), polymyxins, rifamycins, lipiarmycins, quinolones, sulfonamides, macrolides lincosamides, tetracyclines, aminoglycosides, cyclic lipopeptides (e.g., daptomycin), glycylcyclines (e.g., tigecycline), oxazonidinones (e.g., linezolid), and lipiarmycines (e.g., fidazomicin). For example, antibiotics include erythromycin, clindamycin, gentamycin, tetracycline, meclocycline, (sodium) sulfacetamide, benzoyl peroxide, and azelaic acid. Suitable penicillins include amoxicillin, ampicillin, bacampicillin, carbenicillin, cloxacillin, dicloxacillin, flucloxacillin, mezlocillin, nafcillin, oxacillin, penicillin g, penicillin v, piperacillin, pivampicillin, pivmecillinam, and ticarcillin. Exemplary cephalosporins include cefacetrile, cefadroxil, cephalexin, cefaloglycin, cefalonium, cefaloridine, cefalotin, cefapirin, cefatrizine, cefazaflur, cefazedone, cefazolin, cefradine, cefroxadine, ceftezole, cefaclor, cefamandole, cefmetazole, cefonicid, cefotetan, cefoxitin, cefprozil, cefuroxime, cefuzonam, cfcapene, cefdaloxime, cefdinir, cefditoren, cefetamet, cefixime, cefmenoxime, cefodizime, cefotaxime, cefpimizole, cefpodoxime, cefteram, ceftibuten, ceftiofur, ceftiolene, ceftizoxime, ceftriaxone, ceftazidime, cefclidine, cefepime, ceflurprenam, cefoselis, cefozopran, cefpirome, cequinome, ceftobiprole, ceftaroline, cefaclomezine, cefaloram, cefaparole, cefcanel, cefedrlor, cefempidone, cefetrizole, cefivitril, cefmatilen, cefmepidium, cefovecin, cefoxazole, cefrotil, cefsumide, cefuracetime, and ceftioxide. Monobactams include aztreonam. Suitable carbapenems include imipenem/cilastatin, doripenem, meropenem, and ertapenem. Exemplary macrolides include azithromycin, erythromycin, larithromycin, dirithromycin, roxithromycin, and telithromycin. Lincosamides include clindamycin and lincomycin. Exemplary streptogramins include pristinamycin and quinupristin/dalfopristin. Suitable aminoglycoside antibiotics include amikacin, gentamycin, kanamycin, neomycin, netilmicin, paromomycin, streptomycin, and tobramycin. Exemplary quinolones include flumequine, nalidixic acid, oxolinic acid, piromidic acid, pipemidic acid, rosoxacin, ciprofloxacin, enoxacin, lomefloxacin, nadifloxacin, norfloxacin, ofoxacin, pefloxacin, rufloxacin, balofloxacin, gatifloxacin, repafloxacin, levofloxacin, moxifloxacin, pazufloxacin, sparfloxacin, temafloxacin, tosufloxacin, besifloxacin, clinafoxacin, gemifloxacin, sitafloxacin, trovafloxacin, and prulifloxacin. Suitable sulfonamides include sulfamethizole, sulfamethoxazole, and trimethoprim-sulfamethoxazone. Exemplary tetracyclines include demeclocycline, doxycycline, minocycline, oxytetracycline, tetracycline, and tigecycline. Other antibiotics include chloramphenicol, metronidazole, tinidazole, nitrofurantoin, vancomycin, teicoplanin, telavancin, linezolid, cycloserine, rifampin, rifabutin, rifapentin, bacitracin, polymyxin B, viomycin, and capreomycin. The skilled artisan could readily identify other antibiotics useful in the devices and methods described herein.

In some embodiments, the active agent can comprise a drug that reduces macular degeneration. One common current treatment for macular degeneration involves the injection of anti-angiogenesis compounds intraocularly (Lucentis, Eylea). The repeated intraocular injections are sometimes poorly tolerated by patients, leading to low patient compliance. As described herein, the ability to noninvasively refill drug depots for macular degeneration significantly improves patient compliance and patient tolerance of disease, e.g., macular degeneration, treatment. Controlled, repeated release made possible by the methods described herein allows for fewer drug dosings and improved patient comfort.

In some embodiments, the active agent can comprise a drug that prevents immunological rejection. Prior to the invention described herein, to prevent immunological rejection of cells, tissues or whole organs, patients required lifelong therapy of systemic anti-rejection drugs that cause significant side effects and deplete the immune system, leaving patients at greater risk for infection and other complications. The ability to locally release anti-rejection drugs and to repeatedly load compound allows for more local anti-rejection therapy with fewer systemic side effects, improved tolerability and better efficacy.

In some embodiments, the active agent can comprise a drug that prevents thrombosis. Some vascular devices such as vascular grafts and coated stents suffer from thrombosis, in which the body mounts a thrombin-mediated response to the devices. Anti-thrombotic drugs, released from these devices, allows for temporary inhibition of the thrombosis process, but the devices have limited drugs and cannot prevent thrombosis once the drug supply is exhausted. Since these devices are implanted for long periods of time (potentially for the entire lifetime of the patient), temporary thrombosis inhibition is not sufficient. The ability to repeatedly and locally administer anti-thrombotic drugs and release the drug significantly improves clinical outcomes and allows for long-term thrombosis inhibition.

In some embodiments, the active agent can comprise a drug that treats inflammation. Chronic inflammation is characterized by persistent inflammation due to non-degradable pathogens, viral infections, or autoimmune reactions and can last years and lead to tissue destruction, fibrosis, and necrosis. In some cases, inflammation is a local disease, but clinical interventions are almost always systemic. Anti-inflammatory drugs given systemically have significant side-effects including gastrointestinal problems, cardiotoxicity, high blood pressure and kidney damage, allergic reactions, and possibly increased risk of infection. The ability to repeatedly and locally release anti-inflammatory drugs such as NSAIDs and COX-2 inhibitors could reduce these side effects. These methods can provide the ability to deliver long term and local anti-inflammatory care while avoiding systemic side effects.

Other suitable active agents include, for example, immunotherapeutics/immunoadjuvants such as checkpoint inhibitors and STING agonists and agonists for toll-like receptors. Examples include STING ligands (e.g., natural cyclic dinucleotides, cAIMP dinucleotide, fluorine-containing cyclic dinulcoetides, phosphorothioate-containing cyclic dinucleotides, DMXAA); TLR2 ligands; TLR3 ligands (e.g., poly(I:C)); TLR4 ligands (e.g., lipopolysaccharides, monophosphoryl lipid A, CRX-527); TLR5 ligands; TLR7/8 ligands (e.g., gardiquimod, imiquimod, loxoribine, resiquimod, imidazoquinolines, adenine base analogs, benzoazepine analogs); TLR9 ligands (e.g., natural CpG ODNs, phosphorothioate CpG ODNs); TLR13 ligands (e.g., rRNA-derived ODNs); and NOD ligands (e.g., iE-DAP, meso-lanthionine tripeptide, D-gamma-Glu-mDAP, L-Ala-gamm-D-Glu-mDAP).

By way of example, representative active agents include doxorubicin, paclitaxel, gemcitabine, topotecan, tacrolimus, mycophenolic acid, rapamycin, tesiquimod, erlotinib, DMXAA, CdN, temozolomide, and docetaxel.

In some embodiments, the active agent can comprise an integrin-binding peptide, collagen-mimetic peptide, hydrazide, aldehyde, immunomodulating factor, angiogenesis-promoting factor, or cell-signaling factor.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

Synthesis of Alginate Polymers Modified with Depletive and Restorative Azide Modifications.

Alginate polymers modified with azide groups lose the ability to cross-link in the presence of calcium. In these previous alginate modifications, azide-PEG4-amine (azide-amine) was conjugated to alginate through carbodiimide coupling, replacing the carboxyl group on the alginate with an amide. Because these modifications deplete the available carboxyl groups, we name these modifications “depletive”. We hypothesized that modifying alginate polymers with modifications that contain carboxyl groups would restore calcium cross-linking and termed such modifications “restorative”.

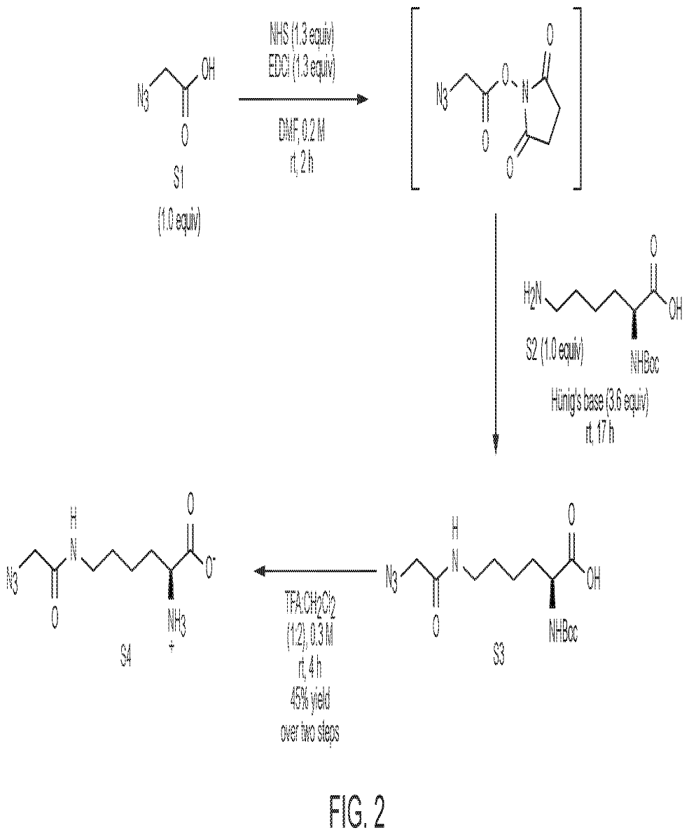

To prepare alginate strands with restored carboxyl groups, we hypothesized that this could be accomplished by conjugating the carboxy-containing azide-lysine S4. Azide-lysine was prepared utilizing a modified three-step literature protocol starting from 2-azidoacetic acid (FIG. 2). Synthesis of compound S4 began with NHS derivatization of 2-azidoacetic acid Si with N-hydroxysuccinimide. The azide-NHS was coupled to a-BOC protected lysine S2 to give α-BOC-γ-azido-lysine S3, which was deprotected to give compound the final azide-lysine S4.

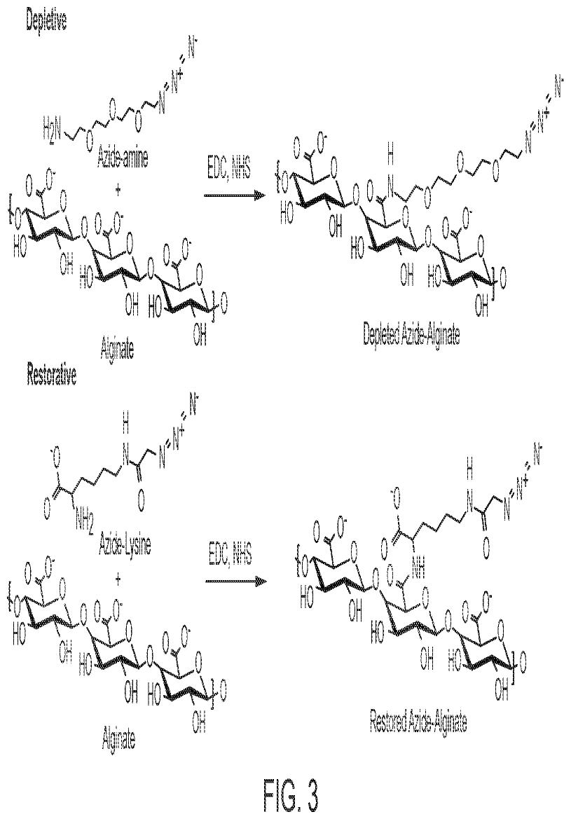

Preparation of alginate modified with depletive and restorative azide modifications was achieved through successive rounds of carbodiimide coupling. Each round utilized N-Ethyl-N′-(3-dimethylaminopropyl)carbodiimide (EDC) (2000 eq.), N-hydroxysuccinimide (NHS) (1000 eq.), and azide (500 eq.) followed by dialysis, workup and measure of degree of substitution. Table 1 shows azide quantitation of alginates for each type of modification after a single and multiple rounds of coupling. The initial coupling of alginate to the carboxyl-depletive modification azide-amine (FIG. 3) yielded a degree of substitution of 87 while coupling to the carboxyl-restorative modification azide-lysine (S4) yielded a degree of substitution of 51. These low-DS materials were submitted to successive rounds of coupling, which increased the DS for both depletive (˜179) and restorative (˜145) modifications.

TABLE 1
Select information for modified alginate polymers used in this study.

| | | | Degree of | Calculated | |
|---|---|---|---|---|---|
| Modification | Alginate | Azide | Substittuion | Molecular | |
| Type | Type | Material | (azides/strand) | Weight (kDa) | DS Classification |
| Restorative | LF 20/40 | Azide-Lysine | 51 | 260 | Low |
| Restorative | LF 20/40 | Azide-Lysine | 145 | 278 | High |
| Depletive | LF 20/40 | Azide-Amine | 87 | 267 | Low |
| Depletive | LF 20/40 | Azide-Amine | 179 | 286 | High |

High DS was achieved through successive carbodiimide couplings using restorative and depletive modifications. Degree of substitution is defined as the number of azides per alginate strand.

Modification of Alginate with Carboxyl-Restorative Groups Efficiently Maintains Calcium Cross-Linking.

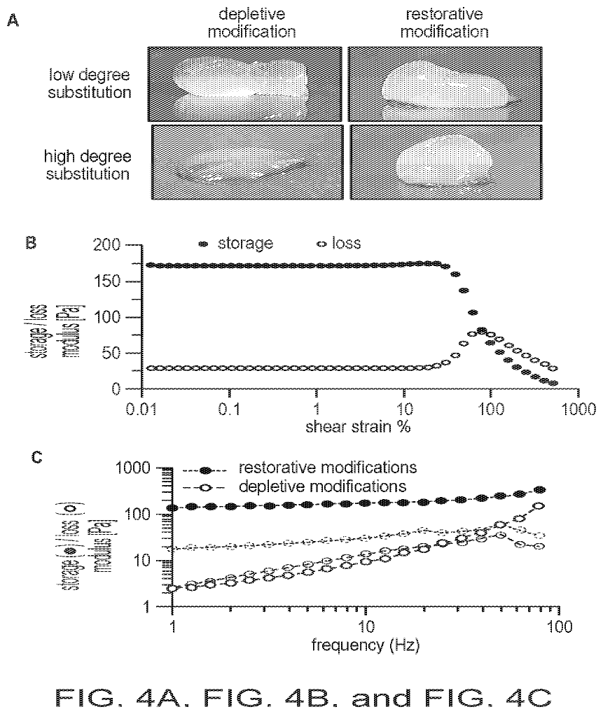

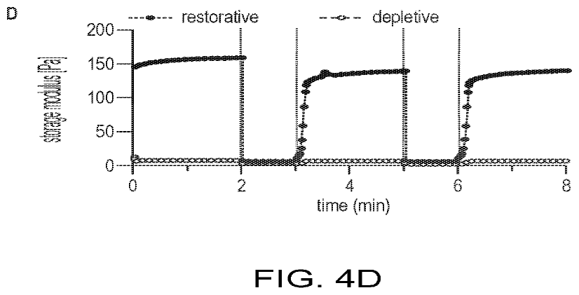

We next assessed whether carboxyl restoration also restores alginate viscosity and calcium cross-linked gel mechanics. General observations revealed that the viscosity of 2% (w/v) alginate solutions of low-DS carboxyl-depleted, low-DS carboxyl-restored and high-DS carboxyl-restored solutions were broadly similar. However, high-DS carboxyl-depleted materials demonstrated a marked decrease in solution viscosity. The 2% alginate solutions were then cross-linked with a 200 mM calcium sulfate solution. At low DS, both gel modifications permitted calcium cross-linking and gel formation. However, at high DS, depletive modification completely eradicated calcium cross-linking and alginate gelation (FIG. 4A). In sharp contrast, alginate gels modified with restorative modifications maintained gel integrity, albeit with some loss in gel stiffness.

Alginate hydrogels formed through vigorous mixing of alginate and calcium sulfate were subjected to rheological testing. Rheological testing confirmed the overall observation that while low-DS alginate with either modification form viscoelastic gels, only the carboxyl-restoring modifications permitted calcium cross-linking at high DS. Because the advantage of restorative modifications was most marked at high-DS, subsequent experiments compared high-DS carboxyl-depleted and -restored alginate gels.

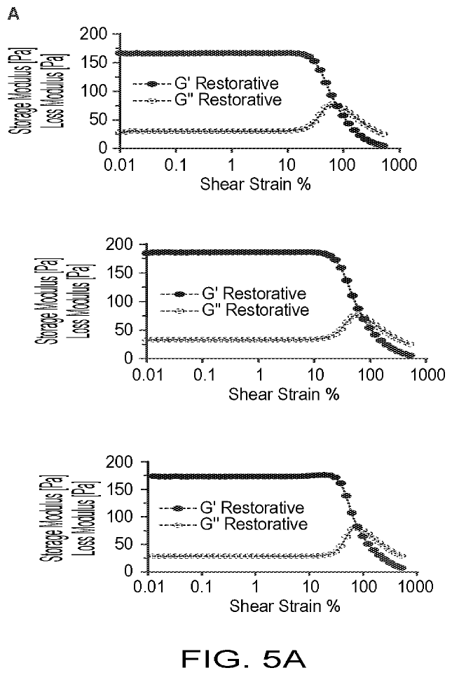

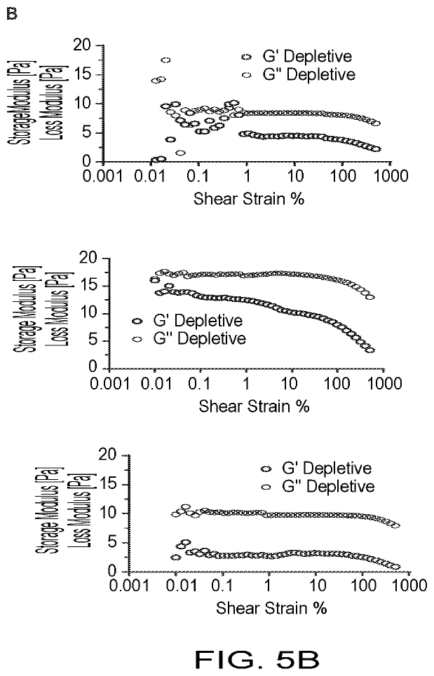

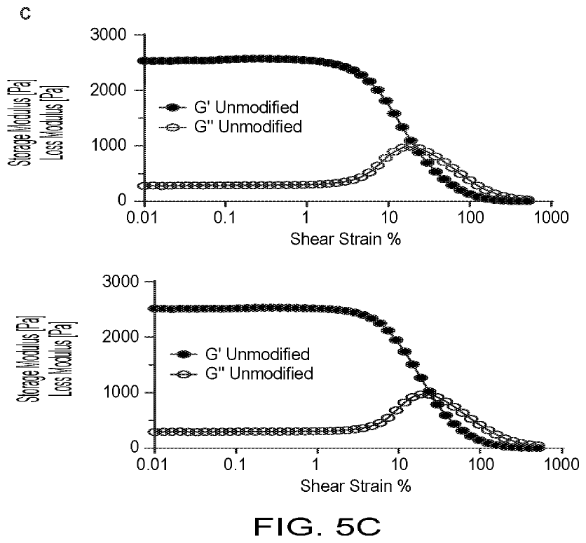

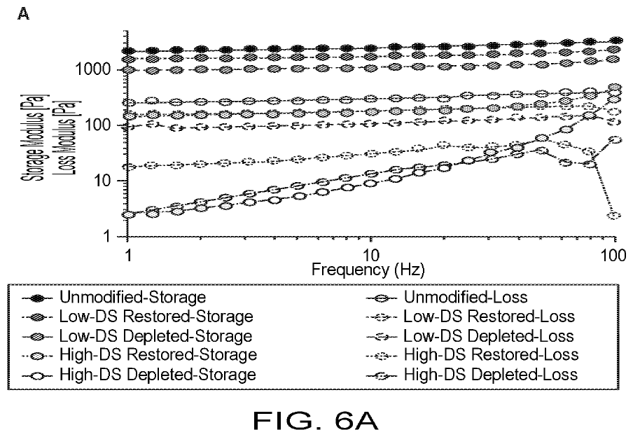

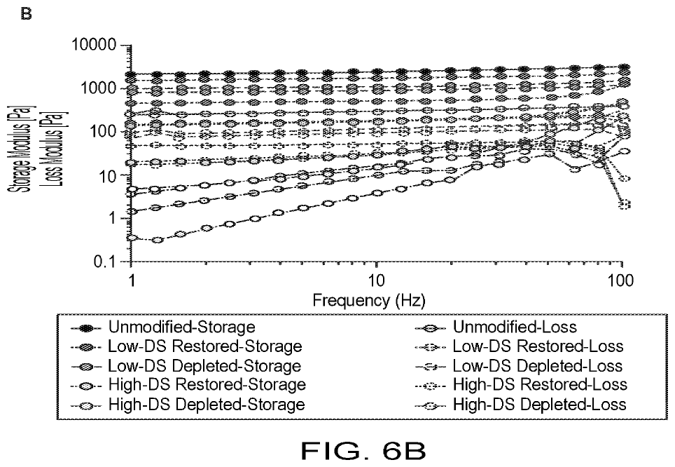

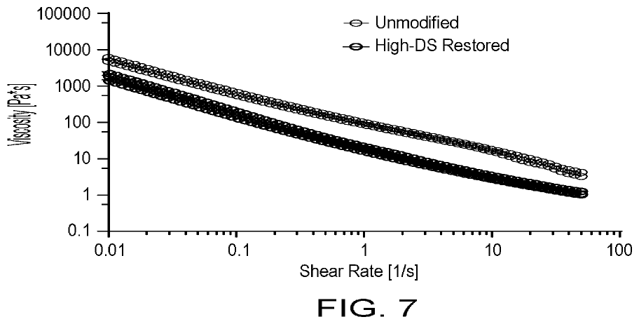

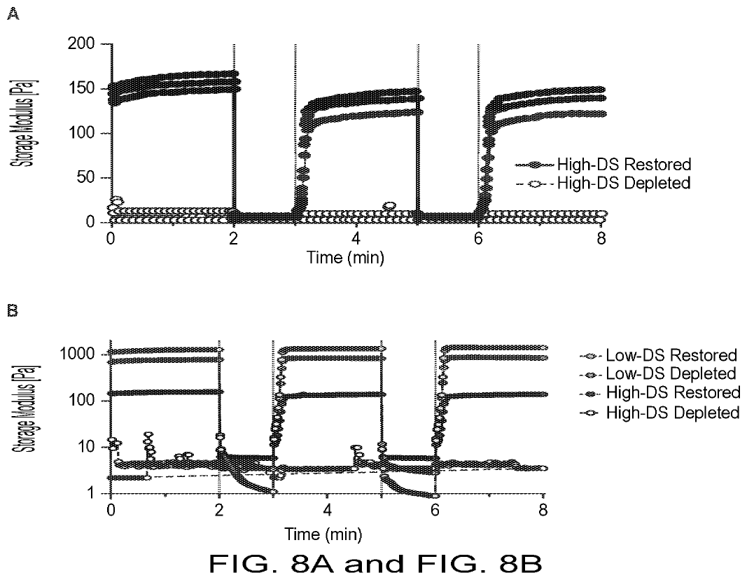

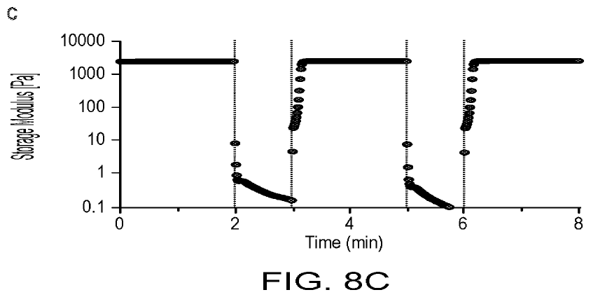

Viscoelastic behaviors and injectability are crucial characteristics to hydrogel function, the restored alginate gels were submitted to strain sweep rheological testing. Alginate with restorative modifications showed gel-like behavior (storage modulus (G′) >loss modulus (G″)) with a relatively strong three-dimensional (3D) network due to the appearance of the G″ peak as shown in FIG. 4B). The linearity limiting value of the linear viscoelastic (LVE) range for the sample with restorative modifications was 26% as compared to 5% for unmodified gels (FIG. 4B, FIG. 5) indicating the modification indeed induced a relatively high degree of cross-linking and strengthened the structural organization of the sample. Frequency sweep tests were performed within the LVE region (FIG. 4C, FIG. 6). The figures showed that at low frequency range, G′>G″ and a flat slope are found in the sample with restorative modifications, whereas, the sample using depletive modifications showed the opposite results. The results confirmed that the sample with restorative modifications (FIG. 4C, red) is in a gel-like state and is relatively more structurally stable when at rest in comparison to the sample using depletive modifications (FIG. 4C, blue). In addition, a rotational test was performed to characterize injectability. The Increased shear rate induced a decrease of viscosity in the alginate gels with restorative modification (shear-thinning behavior) similarly to unmodified alginate (FIG. 7). Finally, self-healing behavior was assessed through cyclic strain time sweep rheology experiments, with restorative samples showing excellent self-healing behavior (FIG. 4D, FIG. 8). Taken together these results demonstrate that in sharp contrast to modification that deplete alginate carboxyl groups, alginate polymers conjugated to restorative modifications maintain calcium cross-linking, gelation, injectability and self-healing properties.

### Alginate Conjugated to Restorative Modifications Demonstrates Improved Gel Retention and Systemic Capture In Vivo.

Hydrogel function requires gels to remain at injected sites. We found that poorly cross-linking hydrogels lose their ability to stay at the injection site and migrate to other parts of the body. We tested the ability of alginate carrying depletive and restorative modifications to be retained at target sites.

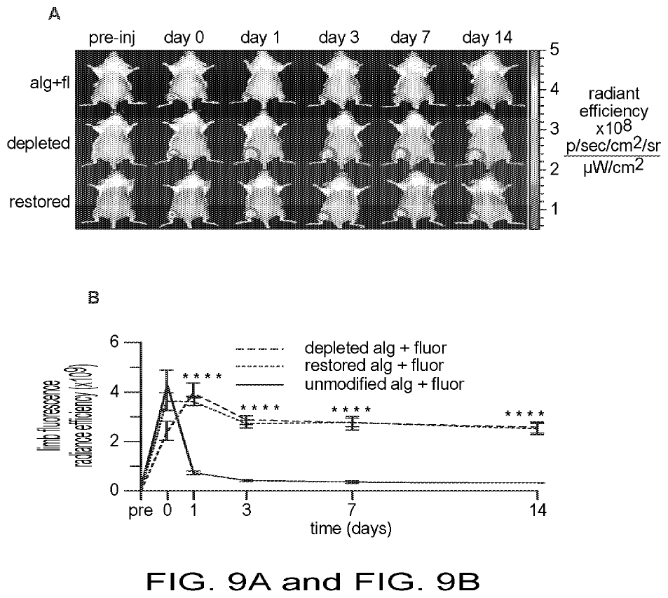

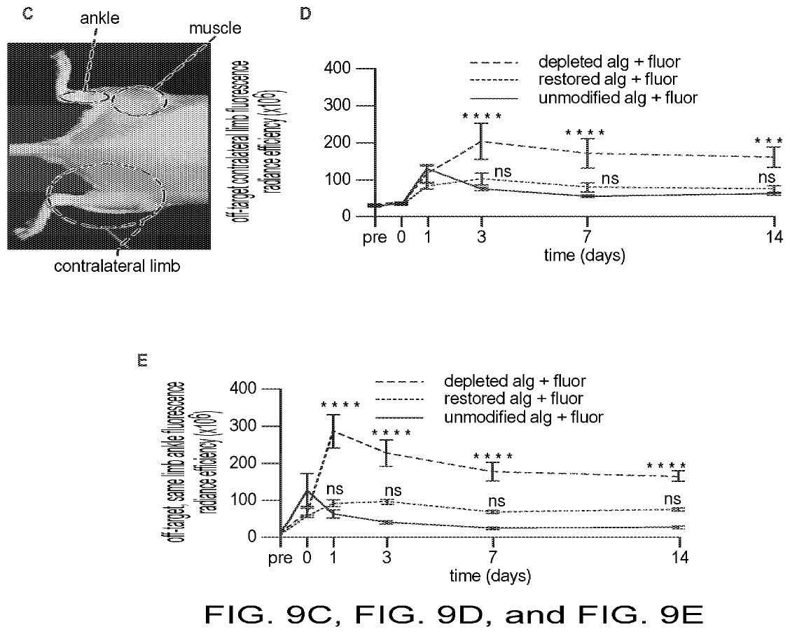

We tested in vivo gel retention of high-DS carboxyl-depleted and carboxyl-restored alginate gels after intramuscular (i.m.) injection into the hind limb. Azide-modified alginate gels were incubated with Cyanine7-dibenzocyclooctyne (Cy7-DBCO), which covalently reacts with azide groups to label the alginate. As a control, unmodified alginate, which lacks the azide modification, was also incubated with Cy7-DBCO. As expected, the unmodified alginate control quickly shed fluorescence signal owing to clearance of the unconjugated dye from the gel (FIG. 9A-B). Both high-DS azide-alginates maintained signal at the injected site and were statistically significant compared to unmodified gels after the first day and through the entire two-week period.

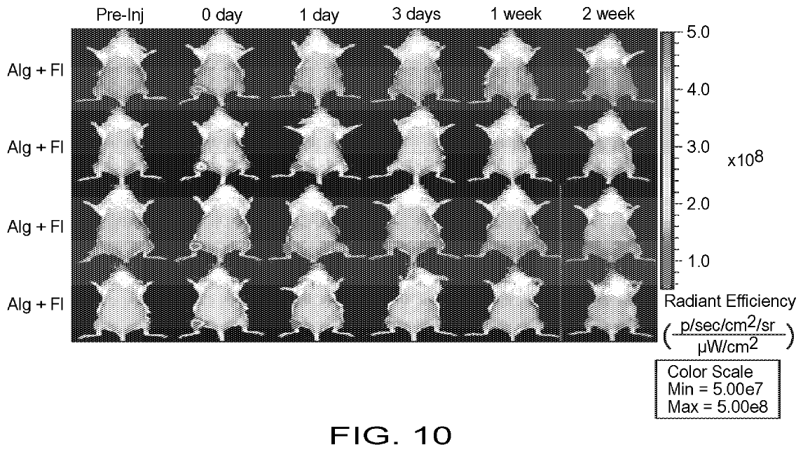

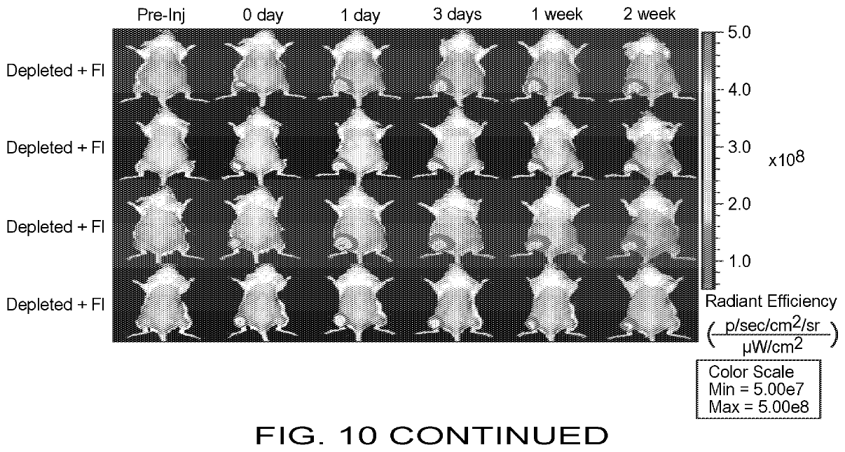

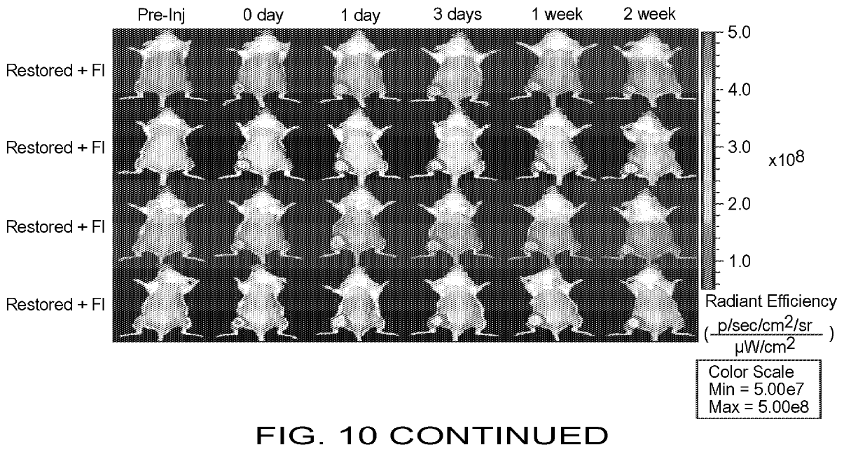

The signal for carboxyl-depleted alginate gels did appear more spread out and more present at off-target locations, such as the ankle of the injected limb as well as the rest of the rodent's body. To quantify the off-target accumulation of alginate at undesired sites, we measured the fluorescence in the ankle of the injected limb and in the non-injected contralateral limb (FIG. 9C). We observed no significant off-target accumulation with the restored alginate as compared to unconjugated Cy7 release from unmodified alginate. However, we found depleted alginate to be significantly different from unmodified alginate after the first day (ankle) and the third day (contralateral limb) and through the entire two-week period (FIG. 9D-E, FIG. 10). Taken together, this data demonstrates that loss of hydrogel mechanical strength leads to migration of material from the injection site to undesired locations throughout the body.

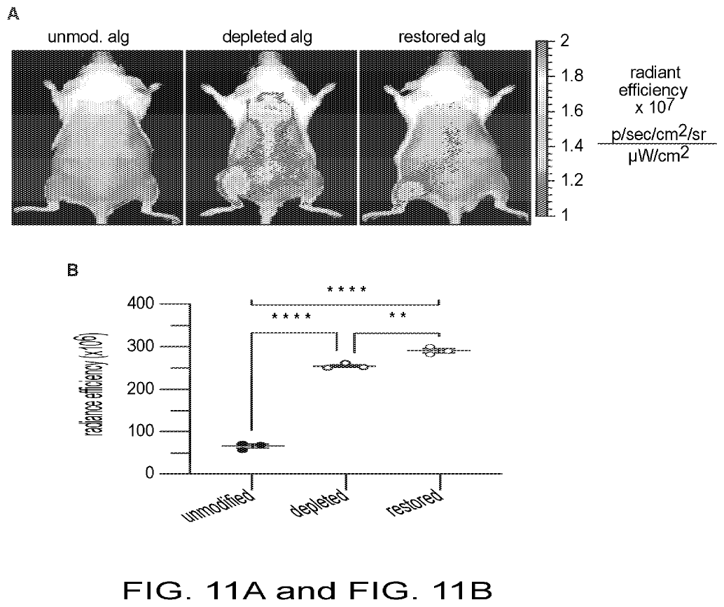

In previous reports, we demonstrated that azide-modified alginate captures circulating DBCO molecules from the blood for applications in ultra-specific drug delivery. Therefore, we tested whether restored alginate could also capture systemically-circulating fluorescent DBCO molecules at intramuscular sites. Alginate with restorative and depletive modifications were injected intramuscularly into the hind limb of outbred CD1 mice. One week after i.m. injections, DBCO-fluorophore was administered intravenously (i.v.), and fluorescence in muscle was measured over time. Unmodified alginate was used as a negative control. One week after i.v. injection, although both gels captured systemically circulating DBCO-Cy7, the restored gel showed significantly higher fluorescence capture as compared to the depleted gel (FIG. 11A-B).

Taken together, the data demonstrates that the improvements in gelation behavior observed in vitro directly translate to in vivo behavior, highlighting the importance of stabilizing hydrogel mechanics for in vivo studies. Restorative modifications enable high levels of modification without sacrificing alginate gelation. The biomaterial change can enable this highly sought-after material to be used in drug depot and implant applications including to capture systemically circulating drug doses from the blood

### Discussion

This paper reports that replacement of carboxyl groups during alginate modification preserves the calcium cross-linking of highly modified alginate polymers. Carboxyl replacement is achieved through the use of carboxyl-containing modification, instead of the commonly used amine groups. Carboxyl restoration allows increasing the degree of substitution while maintaining mechanical properties. In addition, carboxyl restoration improves in vivo retention of highly modified alginate gels at injection sites. Finally, carboxyl restoration improved click-specific targeting of small molecules to locally injected alginate hydrogels.

In previous work, we demonstrated protocols to increase alginate degree of substitution through repeated coupling. However, we and others have shown that alginate gels with high DS fail to cross-link. This observation forced us to resort to using click cross-linkers. In this work, in contrast, we show that click-based cross-linkers are not necessary and that calcium cross-linking can be recovered by restoring the carboxyl groups. Recovery of calcium cross-linking is beneficial because it modulates the self-healing and injectability behavior observed for calcium cross-linked alginate gels. Indeed, although modifications that depleted carboxyl groups on alginate decreased gel mechanics and prevented gelation, modifications that restored carboxyl groups demonstrated calcium cross-linking.

We observed that EDC/NHS-mediated coupling of azide-lysine to alginate showed roughly similar yields to coupling of the azide-amine. The overall yields on these reactions is quite low, with 500 equivalents of azide yielding only 50-80 azide molecules coupled to the alginate. We propose that the poor yields derive from hydrolysis of alginate-NHS esters as well as steric hindrance preventing the amines from accessing the carbonyl of the NHS ester when attached to large alginate polymers. Some variability in the efficiency of coupling was observed for coupling of restorative and depletive modifications. This variability can be attributed to differences in efficiency of EDC coupling and nucleophilic character of the amino groups. Alternatively, the carboxyl groups on the lysine itself can divert EDC and NHS from reacting with alginate carboxyl groups.

Hydrogel retention at introduced sites is central to their use as tissue engineering scaffolds and as cell and drug delivery platforms. It was initially surprising that alginate hydrogels incorporating both restorative and depletive modifications were well retained at the injected tissue sites over two weeks, especially in light of previous published results in which poorly cross-linked alginate rapidly migrated away from the injection site. Thus, despite the complete loss of gelation behavior in vitro, some hydrogel coherence must have remained. However, calcium cross-linked alginate gels containing depletive modification had significantly increased accumulation at off-target sites, indicating that the loss of cross-linking does lead to polymer shedding over time. Lack of precise control over hydrogel localization and off-target accumulation can severely impede clinical translation so the restorative modifications are highly desirable in scaffold and drug delivery platforms that require high DS.

Alginate hydrogels using restorative modification of carboxyl groups demonstrated improved DBCO fluorescent capture from the blood at the site of the depot as compared to highly modified, poorly gelling hydrogels. In previous work, we demonstrated that highly-modified alginates lost their retention capacity after injection into tissues. This difference is very likely due to degradation of the poorly cross-linked hydrogels and their migration away from target sites.

Alginate hydrogels with restorative carboxyl groups improved small molecule capture at intramuscular sites. The amount of DBCO-fluorophore injected is still a small percentage of the theoretical number of available azides and we only expect 1-10% of the total molecule reaching the gel at any point, but the increased chance of an interaction between an azide and a circulating DBCO molecule increases the accumulation

### Conclusions

Taken together, alginate modifications that restore carboxyl groups on the polymer backbone represent a significant improvement in hydrogel and depot stability for in vivo applications. Modifications that restore carboxyl groups make possible mechanically robust, highly modified alginate gels with superior calcium cross-linking behavior, mechanical properties, in vivo retention and depot capture compared to modifications that deplete the carboxyl group.

### Materials and Methods

Reagents. Nutrition grade Alginate (Protanal LF 20/40, average MW=300 kDa, >60% guluronic acid) was purchased from Dupont Nutrition and Health. Calcium sulfate dihydrate (C3771), MES (M3671), and N,N-Diisopropylethylamine (D125806) were purchased from Sigma-Aldrich. Azide-PEG4-amine (1868) was purchased from Lumiprobe corporation. DBCO-sulfo-amine (1227) and DBCO-Cy7 (1047) were purchased from Click Chemistry Tools. 1-Ethyl-3-[3-dimethylaminopropyl]carbodiimide hydrochloride (EDC, 024810) was purchased from Oakwood Chemical. Azidoacetic acid (35109), N-Boc-L-lysine (02708) were purchased from Chem-Impex. N-hydroxysuccinimide was purchased from Chem-Impex International (00182) or Alfa Aesar (A10312). 1-(3-Dimethylaminopropyl)-3-ethylcarbodiimide hydrochloride (A299) was purchased from AK Scientific. N,N-Dimethylformamide (227056) was purchased from Acros Organics. Trifluoroacetic Acid (04901-500), Methanol (A433P-4), Acetonitrile (A998-4) and Toluene (T290-4) were purchased from Fisher Chemical.

Azide-lysine synthesis. (S)-2-ammonio-6-(2-azidoacetamido)hexanoate (S4). Prepared utilizing a modified literature known protocol. To a flame dried 250 mL round bottom flask was added N-hydroxysuccinimide (3.037 g, 26.39 mmol, 1.3 equiv.) and stir bar. Septa was added with an Argon balloon. 101 mL of anhydrous N,N-dimethylformamide (0.2 M) was added and reaction was set to stirring. Septa was removed and 1-(3-dimethylaminopropyl)-3-ethylcarbondiimide hydrochloride (5.06 g, 26.4 mmol, 1.3 equiv.) was added. Septa was replaced and the reaction was set to stirring at room temperature. Then 2-azidoacetic acid (S1) (1.52 mL, 20.3 mmol 1 equiv.) was injected into reaction. Reaction was stirred for 2 hours upon which septa was removed and N-Boc-L-lysine (S2) (5.0 g, 20.3 mmol, 1 equiv.) and N,N-diisopropylethylamine (12.7 mL, 73.1 mmol, 3.6 equiv.) were added in that order. Septa was replaced and reaction was stirred for an additional 17 hours. Over the course of 1 hour, the reaction became an amber color and remained this color during the completion of the reaction. The crude reaction mixture was concentrated on a rotary evaporator followed by high vacuum to remove all DMF and N,N-diisopropylethylamine leaving an amber oil. Toluene was added and then evaporated by rotary evaporator and high vacuum to help remove any trace DMF and N,N-diisopropylethylamine. This crude oil was then taken forward to the next step without purification. To the crude N6-(2-azidoacetyl)-N2-(tert-butoxycarbonyl)-L-lysine (S3) (6.69 g, 20.3 mmol, 1 equiv.), 44 mL of anhydrous dichloromethane and 22 mL of trifluoroacetic acid (2:1 ratio, 0.3 M reaction molarity) was added at room temperature. Reaction was allowed to stir for 4 h, upon which complete conversion was observed on LCMS. Reaction was then concentrated to volume on a rotary evaporator. Then 100 mL of acetonitrile was added and this was concentrated. Then 100 mL of toluene was added and this was also concentrated. This crude oil was then triturated twice with a small volume of methanol followed by addition of copious amounts of diethyl ether providing (S)-2-ammonio-6-(2-azidoacetamido)hexanoate (S4) (3.56 g, 15.5 mmol, 77%) as a light pink/brown solid with trace impurities. Isolated solid was triturated one time further obtaining (S)-2-ammonio-6-(2-azidoacetamido)hexanoate (S4) (2.10 g, 9.16 mmol, 45%) pure as a light tan solid.

Azide conjugation of alginate. Nutrition grade, high guluronic acid content, high molecular weight (MW) alginate (PROTANAL LF 20/40) purchased from Dupont Nutrition and Health was first dissolved in DI water and charcoal was added (0.5 g of charcoal per 1 g of alginate), filtered, and then MES buffer was added to reach the desired 0.5% weight per volume (w/v) concentration (1 g of alginate in 200 mL, 20 μM, 1 eq.) (100 mM MES, 300 mM NaCl, pH: 6.5). To begin the coupling reaction, EDC (40 mM, 2000 eq.) and NHS (20 mM, 1000 eq.) was added to the alginate solution and allowed to stir for 5 minutes. Either azide-lysine (10 mM, 500 eq.) or azide-amine (10 mM, 500 eq.) was added to the solution, and both solutions stirred overnight, covered, at room temperature. The solution was dialyzed against 4 L of water with successively lower salt content, changing solution 2-3 times per day for 4-5 days. Dialyzed solutions were frozen and lyophilized under high vacuum. For additional coupling, the samples were dissolved in 0.5% w/v in 1× MES buffer solution (1 g in 200 mL) and the coupling steps were repeated as described.

Azide quantitation. The number of azides conjugated to the alginate was quantified by looking at the decrease in DBCO absorbance upon incubation of alginate azides with a known excess amount of DBCO. 0.1% w/v (2.5 mg in 2.5 ml) alginate solutions were made in phosphate buffer solution (PBS). 80 μM solutions of DBCO-amine (Click Chemistry Tools-1227) were made and three different amounts of alginate was added (400 pmol, 800 pmol and 1.6 nmol of alginate) to separate 80 μM solutions of DBCO-amine. A DBCO negative control solution was also tested along with a positive control consisting of DBCO reacted with sodium azide (1 umol, 2500 eq.). Spectrophotometry was performed using a UV/Vis spectrophotometer (Thermo Scientific Nanodrop 2000c) using a cuvette with a 1 cm pathlength. Absorbance changes were observed at 308 nm wavelength. This process was repeated with replicates of the 0.1% alginate (alg) solutions and the absorbance values were averaged. Decrease in absorbance in alginate samples compared to DBCO negative control indicated the quantity of azides that reacted with DBCO.

DS=mol azide*MW alg/mass azalg−mol azide*MW azide

Gel Formation. Alginate was dissolved in PBS (2% w/v, 20 mg in 1 mL). 10:1 ratio of the 2% w/v alginate solution was mixed with a calcium sulfate solution (final concentration of 18.2 mM) in a two syringe system while minimizing air. The solutions were mixed by pushing the syringe barrels back and forth 10 times. This system was used to create gel sizes ranging from 400 μL to 1 mL.

Rheology Testing. Alginate was cross-linked as described in section 5.4, with 1 mL gels mixed and injected into a 24-well plate. The gel were allowed at least 24 hours to settle and then collected for rheology testing. Rheology test of prepared gel was performed on a Molecular Compact Rheometer (MCR302, Anton Paar, Graz, Austria). A cone plate geometry of a 50 mm diameter and 1 degree (CP50-1/TG, Anton Paar, Graz, Austria) was used in this experiment. After installing the geometry, zero force and zero gap with a truncation gap of 0.1 mm was set. Before analysis began, to calibrate the system, adjust measurement system inertia and adjust system tests were performed. After calibration was done, 1 mL of gel samples (gently mashed with a lab spatula) was placed on the preinstalled temperature-controlled Peltier plate at 21° C. Geometry cone was set at the truncation height and access of samples were trimmed. Before each test, cone geometry and Peltier plate were cleaned with distilled water and absolute ethanol and instrument was calibrated to ensure the consistency.

To determine the rheological characteristics of the gels, the following simultaneous tests were performed using the method of Chen et al. with slight modification.

Time sweep: Two minutes of time sweep was performed at 0.2% strain and a frequency of 10 Hz and a total 150 data points at a constant rate were collected before and between each test performed.

Amplitude sweep: Amplitude sweep test of the gel samples was performed on a logarithmic ramp ranging from 0.01 to 500% at 10 Hz with 3 seconds of conditioning and sampling time, and 10 data points per decade were recorded.

Frequency sweep: Frequency sweep on a logarithmic ramp ranging from 0.01-100 Hz at 0.2% strain was performed with 3 seconds of sample conditioning and sampling time, and 10 data points per decade were recorded.

Cyclic amplitude sweep: A continuous cyclic amplitude sweep test was performed in five intervals (1-5). Intervals 1, 3 and 5 were set at 0.2% strain, 10 Hz for 2 minutes, whereas intervals 2 and 4 set at 500% strain, 10 Hz for one minute.

Shear rate ramp: Two continuous shear rate ramps from 0 to 50 s-1 and 50 to 0 s-1 for 2.5 minutes each were performed to study the continuous flow behavior of the gel. Total of 74 data points with 20 data points per decade was recorded.

Gel retention of intramuscular implanted alginate gels. All animal work was done in compliance with institutional ethical use protocols, including the NIH Guide for Care and Use of Laboratory Animals. Unmodified and modified alginate were prepared as described in section 5.4 but were instead dissolved in a 24 μM DBCO-Cy7 in PBS solution (2% w/v, 20 mg in 1 mL) resulting in a final concentration of 21.8 μM after cross-linking the gel. 12-week-old CD1 mice (Charles River, 022) were injected intramuscularly in the left limb with 50 μL of fluorescently labeled unmodified alginate, depleted azide-alginate, or restored azide-alginate (n=4). Cy7 fluorescence was monitored over two weeks using an IVIS imager to obtain a fluorescence signal. ICG/ICG excitation and emission filters were used for all IVIS images presented and no image math in the Living Image software was performed. For all IVIS images, only radiance efficiency values were used to normalize the data over variable exposure times. Regions of Interest (ROIs) were used to sum the fluorescent signal associated with the injected calf, the injected ankle, and the contralateral calf.

Systemic capture of fluorophore in intramuscular implanted alginate gels. All animal work was done in compliance with institutional ethical use protocols, including the NIH Guide for Care and Use of Laboratory Animals. Unmodified and modified alginate were prepared as described in section 5.4. 12-week-old CD1 mice (Charles River, 022) were injected intramuscularly in the left limb with 50 μL of unmodified alginate, depleted azide-alginate, or restored azide-alginate (n=3). 5 g/L stock of DBCO-Cy7 in water was prepared and diluted 100× and sterile filtered. 1 week after injection, 100 μL of the sterile 50 mg/L DBCO-Cy7 solution was injected retro-orbitally. Cy7 fluorescence was measured after 1 week using an IVIS imager to obtain a fluorescence signal. ICG/ICG excitation and emission filters were used for all IVIS images presented and no image math in the Living Image software was performed. For all IVIS images, only radiance efficiency values were used to normalize the data over variable exposure times. ROIs were used to sum the fluorescent signal associated with the left calf.

### REFERENCES

A. Jull, N. Walker, V. Parag, P. Molan, A. Rodgers, Randomized clinical trial of honey-impregnated dressings for venous leg ulcers, Br. J. Surg. 95 (2008) 175-182.
A. Lueckgen, D. S. Garske, A. Ellinghaus, D. J. Mooney, G. N. Duda, A. Cipitria, Dual alginate crosslinking for local patterning of biophysical and biochemical properties, Acta Biomater. 115 (2020) 185-196.
A. Lueckgen, D. S. Garske, A. Ellinghaus, R. M. Desai, A. G. Stafford, D. J. Mooney, G. N. Duda, A. Cipitria, Hydrolytically-degradable click-crosslinked alginate hydrogels, Biomaterials. 181 (2018) 189-198.
A. Pal, B. L. Vernon, M. Nikkhah, Therapeutic neovascularization promoted by injectable hydrogels, Bioact Mater. 3 (2018) 389-400.
A. J. Vegas, O. Veiseh, J. C. Doloff, M. Ma, H. H. Tam, K. Bratlie, J. L₁, A. R. Bader, E. Langan, K. Olejnik, P. Fenton, J. W. Kang, J. Hollister-Locke, M. A. Bochenek, A. Chiu, S. Siebert, K. Tang, S. Jhunjhunwala, S. Aresta-Dasilva, N. Dholakia, R. Thakrar, T. Vietti, M. Chen, J. Cohen, K. Siniakowicz, M. Qi, J. McGarrigle, S. Lyle, D. M. Harlan, D. L. Greiner, J. Oberholzer, G. C. Weir, R. Langer, D. G. Anderson, Erratum: Corrigendum: Combinatorial hydrogel library enables identification of materials that mitigate the foreign body response in primates, Nat. Biotechnol. 34 (2016) 666-666.
A. K. Vellimana, V. R. Recinos, L. Hwang, K. D. Fowers, K. W. L₁, Y. Zhang, S. Okonma, C. G. Eberhart, H. Brem, B. M. Tyler, Combination of paclitaxel thermal gel depot with temozolomide and radiotherapy significantly prolongs survival in an experimental rodent glioma model, J. Neurooncol. 111 (2013) 229-236.
C. Bastiancich, J. Bianco, K. Vanvarenberg, B. Ucakar, N. Joudiou, B. Gallez, G. Bastiat, F. Lagarce, V. Preat, F. Danhier, Injectable nanomedicine hydrogel for local chemotherapy of glioblastoma after surgical resection, J. Control. Release. 264 (2017) 45-54.
C. Garcia-Astrain, L. Averous, Synthesis and evaluation of functional alginate hydrogels based on click chemistry for drug delivery applications, Carbohydr. Polym. 190 (2018) 271-280.
C. Wang, R. R. Varshney, D.-A. Wang, Therapeutic cell delivery and fate control in hydrogels and hydrogel hybrids, Adv. Drug Deliv. Rev. 62 (2010) 699-710.
C. A. DeForest, B. D. Polizzotti, K. S. Anseth, Sequential click reactions for synthesizing and patterning three-dimensional cell microenvironments, Nature Materials. 8 (2009) 659-664.
C. K. Kuo, P. X. Ma, Ionically crosslinked alginate hydrogels as scaffolds for tissue engineering: part 1. Structure, gelation rate and mechanical properties, Biomaterials. 22 (2001) 511-521.
C. T. Moody, S. Palvai, Y. Brudno, Click cross-linking improves retention and targeting of refillable alginate depots, Acta Biomater. 112 (2020) 112-121.
D. Jain, D. Bar-Shalom, Alginate drug delivery systems: application in context of pharmaceutical and biomedical research, Drug Dev. Ind. Pharm. 40 (2014) 1576-1584.
D. Zeng, N. S. Lee, Y. Liu, D. Zhou, C. S. Dence, K. L. Wooley, J. A. Katzenellenbogen, M. J. Welch, 64Cu Core-labeled nanoparticles with high specific activity via metal-free click chemistry, ACS Nano. 6 (2012) 5209-5219.
E. A. Silva, D. J. Mooney, Spatiotemporal control of vascular endothelial growth factor delivery from injectable hydrogels enhances angiogenesis, Journal of Thrombosis and Haemostasis. 5 (2007) 590-598.
F. de la Portilla, S. Dios-Barbeito, M. V. Maestre-Sańchez, J. M. Vizquez-Monchul, A. M. Garcia-Cabrera, I. Ramallo, M. L. Reyes-Diaz, Feasibility and safety of calcium alginate hydrogel sealant for the treatment of cryptoglandular fistula-in-ano: phase I/IIa clinical trial, Colorectal Dis. (2021).
G. Choe, J. Park, H. Park, J. Y. Lee, Hydrogel Biomaterials for Stem Cell Microencapsulation, Polymers. 10 (2018).
G. Eke, N. Mangir, N. Hasirci, S. MacNeil, V. Hasirci, Development of a UV crosslinked biodegradable hydrogel containing adipose derived stem cells to promote vascularization for skin wounds and tissue engineering, Biomaterials. 129 (2017) 188-198.
G. Orive, S. K. Tam, J. L. Pedraz, J.-P. Halle, Biocompatibility of alginate-poly-l-lysine microcapsules for cell therapy, Biomaterials. 27 (2006) 3691-3700.
H. Wen, W. Xiao, S. Biswas, Z.-Q. Cong, X.-M. Liu, K. S. Lam, Y.-H. Liao, W. Deng, Alginate Hydrogel Modified with a Ligand Interacting with 301 Integrin Receptor Promotes the Differentiation of 3D Neural Spheroids toward Oligodendrocytes in Vitro, ACS Appl. Mater. Interfaces. 11 (2019) 5821-5833.
J. L₁, D. J. Mooney, Designing hydrogels for controlled drug delivery, Nat Rev Mater. 1 (2016).
J. Sayag, S. Lieaume, S. Bohbot, Healing properties of calcium alginate dressings, J. Wound Care. 5 (1996) 357-362.
J. Yang, Y. Liu, L. He, Q. Wang, L. Wang, T. Yuan, Y. Xiao, Y. Fan, X. Zhang, Icariin conjugated hyaluronic acid/collagen hydrogel for osteochondral interface restoration, Acta Biomater. 74 (2018) 156-167.
J. A. Johnson, J. M. Baskin, C. R. Bertozzi, J. T. Koberstein, N. J. Turro, Copper-free click chemistry for the in situ crosslinking of photodegradable star polymers, Chem. Commun. (2008) 3064-3066.
J. A. Rowley, G. Madlambayan, D. J. Mooney, Alginate hydrogels as synthetic extracellular matrix materials, Biomaterials. 20 (1999) 45-53.
J. D. Medina, M. Alexander, M. D. Hunckler, M. A. Fernández-Yagüe, M. M. Coronel, A. M. Smink, J. R. Lakey, P. de Vos, A. J. Garcia, Functionalization of alginate with extracellular matrix peptides enhances viability and function of encapsulated porcine islets, Adv. Healthc. Mater. 9 (2020) e2000102.
J. L. Madrigal, S. Shams, R. S. Stilhano, E. A. Silva, Characterizing the encapsulation and release of lentivectors and adeno-associated vectors from degradable alginate hydrogels, Biomater Sci. 7 (2019) 645-656.
J. M. Mejia Oneto, I. Khan, L. Seebald, M. Royzen, In Vivo Bioorthogonal Chemistry Enables Local Hydrogel and Systemic Pro-Drug To Treat Soft Tissue Sarcoma, ACS Cent Sci. 2 (2016) 476-482.
K. M. Gattás-Asfura, C. L. Stabler, Chemoselective cross-linking and functionalization of alginate via Staudinger ligation, Biomacromolecules. 10 (2009) 3122-3129.
L. Yang, Y. L₁, Y. Gou, X. Wang, X. Zhao, L. Tao, Improving tumor chemotherapy effect using an injectable self-healing hydrogel as drug carrier, Polym. Chem. 8 (2017) 5071-5076.
L. Zou, A. S. Braegelman, M. J. Webber, Spatially Defined Drug Targeting by in Situ Host-Guest Chemistry in a Living Animal, ACS Cent Sci. 5 (2019) 1035-1043.
M. Georg Jensen, M. Kristensen, A. Astrup, Effect of alginate supplementation on weight loss in obese subjects completing a 12-wk energy-restricted diet: a randomized controlled trial, Am. J. Clin. Nutr. 96 (2012) 5-13.
M. Gionet-Gonzales, A. Casella, D. Diloretto, C. Ginnell, K. H. Griffin, A. Bigot, J. K. Leach, Sulfated alginate hydrogels prolong the therapeutic potential of MSC spheroids by sequestering the secretome, Adv. Healthc. Mater. (2021) e2101048.
M. Ménard, J. Dusseault, G. Langlois, W. E. Baille, S. K. Tam, L. ′hocine Yahia, X. X. Zhu, J.-P. Hallé, Role of protein contaminants in the immunogenicity of alginates, J. Biomed. Mater. Res. B Appl. Biomater. 93 (2010) 333-340.
M. A. Bochenek, O. Veiseh, A. J. Vegas, J. J. McGarrigle, M. Qi, E. Marchese, M. Omami, J. C. Doloff, J. Mendoza-Elias, M. Nourmohammadzadeh, A. Khan, C.-C. Yeh, Y. Xing, D. Isa, S. Ghani, J. L₁, C. Landry, A. R. Bader, K. Olejnik, M. Chen, J. Hollister-Lock, Y. Wang, D. L. Greiner, G. C. Weir, B. L. Strand, A. M. A. Rokstad, I. Lacik, R. Langer, D. G. Anderson, J. Oberholzer, Alginate encapsulation as long-term immune protection of allogeneic pancreatic islet cells transplanted into the omental bursa of macaques, Nat. Biomed. Eng. 2 (2018) 810-821.
M. H. Chen, L. L. Wang, J. J. Chung, Y.-H. Kim, P. Atluri, J. A. Burdick, Methods To Assess Shear-Thinning Hydrogels for Application As Injectable Biomaterials, ACS Biomater Sci Eng. 3 (2017) 3146-3160.
M. H. Ghanian, H. Mirzadeh, H. Baharvand, In Situ Forming, Cytocompatible, and Self-Recoverable Tough Hydrogels Based on Dual Ionic and Click Cross-Linked Alginate, Biomacromolecules. 19 (2018) 1646-1662.
M. R. Adams, C. T. Moody, J. L. Sollinger, Y. Brudno, Extracellular-Matrix-Anchored Click Motifs for Specific Tissue Targeting, Mol. Pharm. 17 (2020) 392-403.
N. Xu, J. Xu, X. Zheng, J. Hui, Preparation of Injectable Composite Hydrogels by Blending Poloxamers with Calcium Carbonate-Crosslinked Sodium Alginate, ChemistryOpen. 9 (2020) 451-458.
N. T. T. Uyen, Z. A. A. Hamid, N. X. T. Tram, N. Ahmad, Fabrication of alginate microspheres for drug delivery: A review, Int. J. Biol. Macromol. 153 (2020) 1035-1046.
O. Veiseh, J. C. Doloff, M. Ma, A. J. Vegas, H. H. Tam, A. R. Bader, J. L₁, E. Langan, J. Wyckoff, W. S. Loo, S. Jhunjhunwala, A. Chiu, S. Siebert, K. Tang, H.-L. Jennifer, A.-D. Stephanie, M. Bochenek, M.-E. Joshua, Y. Wang, M. Qi, D. M. Lavin, M. Chen, N. Dholakia, R. Thakrar, I. Lacik, G. C. Weir, J. Oberholzer, D. L. Greiner, R. Langer, D. G. Anderson, Size- and shape-dependent foreign body immune response to materials implanted in rodents and non-human primates, Nat. Mater. 14 (2015) 643-651.
P. Agarwalla, E. A. Ogunnaike, S. Ahn, F. S. Ligler, G. Dotti, Y. Brudno, Scaffold-Mediated Static Transduction of T Cells for CAR-T Cell Therapy, Adv. Healthc. Mater. (2020) 2000275.
R. J. Lee, A. Hinson, R. Bauernschmitt, K. Matschke, Q. Fang, D. L. Mann, R. Dowling, N. Schiller, H. N. Sabbah, The feasibility and safety of Algisyl-LVR™ as a method of left ventricular augmentation in patients with dilated cardiomyopathy: Initial first in man clinical results, Int. J. Cardiol. 199 (2015) 18-24.
R. M. Desai, S. T. Koshy, S. A. Hilderbrand, D. J. Mooney, N. S. Joshi, Versatile click alginate hydrogels crosslinked via tetrazine-norbornene chemistry, Biomaterials. 50 (2015) 30-37.
R.-S. Hsu, J.-H. Fang, W.-T. Shen, Y.-C. Sheu, C.-K. Su, W.-H. Chiang, S.-H. Hu, Injectable DNA-architected nanoraspberry depot-mediated on-demand programmable refilling and release drug delivery, Nanoscale. 12 (2020) 11153-11164.
R. S. Stilhano, J. L. Madrigal, K. Wong, P. A. Williams, P. K. M. Martin, F. S. M. Yamaguchi, V. Y. Samoto, S. W. Han, E. A. Silva, Injectable alginate hydrogel for enhanced spatiotemporal control of lentivector delivery in murine skeletal muscle, J. Control. Release. 237 (2016) 42-49.
S. B. Stephan, A. M. Taber, I. Jileaeva, E. P. Pegues, C. L. Sentman, M. T. Stephan, Biopolymer implants enhance the efficacy of adoptive T-cell therapy, Nat. Biotechnol. 33 (2015) 97-101.
S. D. Anker, A. J. S. Coats, G. Cristian, D. Dragomir, E. Pusineri, M. Piredda, L. Bettari, R. Dowling, M. Volterrani, B.-A. Kirwan, G. Filippatos, J.-L. Mas, N. Danchin, S. D. Solomon, R. J. Lee, F. Ahmann, A. Hinson, H. N. Sabbah, D. L. Mann, A prospective comparison of alginate-hydrogel with standard medical therapy to determine impact on functional capacity and clinical outcomes in patients with advanced heart failure (AUGMENT-HF trial), Eur. Heart J. 36 (2015) 2297-2309.
S. H. Hong, Y. L₁, J. B. Eom, Y. Choi, Responsive alginate-cisplatin nanogels for selective imaging and combined chemo/radio therapy of proliferating macrophages, Quant. Imaging Med. Surg. 8 (2018) 733-742.
S. J. Bidarra, C. C. Barrias, P. L. Granja, Injectable alginate hydrogels for cell delivery in tissue engineering, Acta Biomater. 10 (2014) 1646-1662.
S. M. Willerth, S. E. Sakiyama-Elbert, Combining stem cells and biomaterial scaffolds for constructing tissues and cell delivery, StemJournal. 1 (2019) 1-25.
S. N. Pawar, Chapter 8-Chemical Modification of Alginate, in: J. Venkatesan, S. Anil, S.-K. Kim (Eds.), Seaweed Polysaccharides, Elsevier, 2017: pp. 111-155.
T. Joki, M. Machluf, A. Atala, J. Zhu, N. T. Seyfried, I. F. Dunn, T. Abe, R. S. Carroll, P. M. Black, Continuous release of endostatin from microencapsulated engineered cells for tumor therapy, Nat. Biotechnol. 19 (2001) 35-39.
T. Li, Z. Li, F. Nan, J. Dong, Y. Deng, Q. Yu, T. Zhang, Construction of a novel inducing system with multi-layered alginate microcapsules to regulate differentiation of neural precursor cells from bone mesenchymal stem cells, Medical Hypotheses. 85 (2015) 910-913.
T. Maguire, E. Novik, R. Schloss, M. Yarmush, Alginate-PLL microencapsulation: Effect on the differentiation of embryonic stem cells into hepatocytes, Biotechnology and Bioengineering. 93 (2006) 581-591.
T. A. Read, D. R. Sorensen, R. Mahesparan, P. O. Enger, R. Timpl, B. R. Olsen, M. H. Hjelstuen, O. Haraldseth, R. Bjerkvig, Local endostatin treatment of gliomas administered by microencapsulated producer cells, Nat. Biotechnol. 19 (2001) 29-34.
T. A. S. Selmi, P. Verdonk, P. Chambat, F. Dubrana, J.-F. Potel, L. Barnouin, P. Neyret, Autologous chondrocyte implantation in a novel alginate-agarose hydrogel: outcome at two years, J. Bone Joint Surg. Br. 90 (2008) 597-604.
X. Chen, F. Li, Y.-W. Wu, Chemical labeling of intracellular proteins via affinity conjugation and strain-promoted cycloadditions in live cells, Chem. Commun. 51 (2015) 16537-16540.
X. Liu, P. Gong, P. Song, F. Xie, A. Lee Miller II, S. Chen, L. Lu, Rapid conjugation of nanoparticles, proteins and siRNAs to microbubbles by strain-promoted click chemistry for ultrasound imaging and drug delivery, Polym. Chem. 10 (2019) 705-717.
X. Zhang, K. Wang, J. Hu, Y. Zhang, Y. Dai, F. Xia, Role of a high calcium ion content in extending the properties of alginate dual-crosslinked hydrogels, J. Mater. Chem. A Mater. Energy Sustain. 8 (2020) 25390-25401.
Y. Brudno, M. J. Pezone, T. K. Snyder, O. Uzun, C. T. Moody, M. Aizenberg, D. J. Mooney, Replenishable drug depot to combat post-resection cancer recurrence, Biomaterials. 178 (2018) 373-382.
Y. Brudno, R. M. Desai, B. J. Kwee, N. S. Joshi, M. Aizenberg, D. J. Mooney, In vivo targeting through click chemistry, ChemMedChem. 10 (2015) 617-620.
Y. Hui, Microorganisms and Microbially Derived Ingredients Used in Foods, Handbook of Plant-Based Fermented Food and Beverage Technology, Second Edition. (2012) 771-790.
Y. Luo, K. R. Kirker, G. D. Prestwich, Cross-linked hyaluronic acid hydrogel films: new biomaterials for drug delivery, J. Control. Release. 69 (2000) 169-184.

What is claimed is:

1. A modified alginate comprising one or more covalently modified monomers defined by Formula I 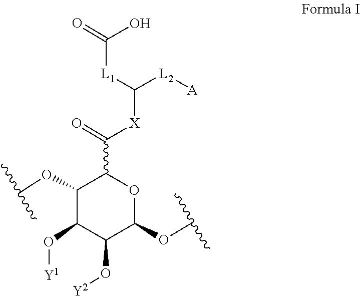
wherein:
X is O, S, or NR₃;
R₃ is hydrogen, alkyl, alkenyl, alkynyl, aryl, heteroaryl, cycloalkyl, or heterocycloalkyl;
L₁ and L₂ are each independently absent or represent a linking group;
A represents a functional moiety; and
Y₁ and Y₂ independently are hydrogen or —PO(OR)₂, or Y₂ is absent, and Y₁, together with the two oxygen atoms to which Y₁ and Y₂ are attached form a cyclic structure as shown below 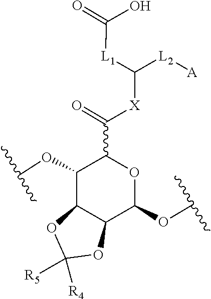
wherein
wherein R₄ and R₅ are, independently, hydrogen, alkyl, alkenyl, alkynyl, aryl, heteroaryl, cycloalkyl, heterocycloalkyl, alkoxy, aroxy, alkylthio, carbonyl, carboxyl, amino, or amido; or
R₄ and R₅, together with the carbon atom to which they are attached, form a 3- to 8-membered unsubstituted or substituted carbocyclic or heterocyclic ring.

2. The modified alginate of claim 1, wherein the modified alginate comprises a singularly modified alginate polymer.

3. The modified alginate of any of claims 1-2, wherein Y₁ and Y₂ are both H.

4. The modified alginate of any of claims 1-3, wherein X is NH.

5. The modified alginate of any of claims 1-4, wherein A comprises a click motif.

6. The modified alginate of claim 5, wherein the click motif comprises an azide, a phosphine, a cyclooctene (e.g., a transcyclooctene (TCO)), a norbornene (NOR), a tetrazine (Tz), an alkyne, a cyclooctyne such as dibenzocyclooctyne (DBCO), or a quadricyclane.

7. The modified alginate of any of claims 1-4, wherein A comprises an active agent.

8. The modified alginate of claim 7, wherein active agent comprises a therapeutic agent, a prophylactic agent, a diagnostic agent, or a combination thereof.

9. The modified alginate of any of claims 1-8, wherein L₁ is absent.

10. The modified alginate of any of claims 1-8, wherein L₁ comprises a C₁₋₄ alkyl group.

11. The modified alginate of any of claims 1-10, wherein L₂ is absent.

12. The modified alginate of any of claims 1-10, wherein L₂ comprises an alkyl, alkoxy, alkylaryl, alkylheteroaryl, alkylcycloalkyl, alkylheterocycloalkyl, alkylthio, alkylsulfinyl, alkylsulfonyl, alkylamino, dialkylamino, alkylcarbonyl, alkoxycarbonyl, alkylaminocarbonyl, dialkylaminocarbonyl, or polyamino group.

13. A hydrogel matrix or scaffold comprising the modified alginate defined by any of claims 1-12 crosslinked with a divalent cation, such as Ca²⁺, Mg²⁺, and/or Ba²⁺.

14. A method of derivatizing an alginate backbone with and active agent, the method comprising contacting the modified alginate defined by any of claims 1-12 with an active agent comprising a second functional moiety complementary and reactive with the functional moiety present in the modified alginate under conditions effective for the second functional moiety to react with the functional moiety present in the modified alginate to form a covalent bond, covalently linking the active agent to the alginate backbone.

15. The method of claim 14, wherein the active agent comprises a therapeutic agent, a prophylactic agent, a diagnostic agent, or a combination thereof.

16. A substituted alginate strand comprising alginate strand coupled to a functional moiety via a linker, wherein the linker comprises a nucleophilic terminus and a carboxyl group of the nucleophilic terminus; and wherein the nucleophilic terminus is coupled to a carboxyl group on the alginate strand.

17. The substituted alginate strand of claim 16, wherein the functional moiety comprises azide, tetrazine, alkyne, cyclooctyne, cycloocetene, norbornene, triazole, triazole-thiomorpholine dioxide, integrin-binding peptide, collagen-mimetic peptide, hydrazide, aldehyde, immunomodulating factor, angiogenesis-promoting factor, or cell-signaling factor,

18. The substituted alginate strand of claim 16 or 17, wherein the linker comprises a nucleophilic group such as an amine, alcohol, thiol, hydrazine, hydrazide etc.

19. A hydrogel matrix or scaffold comprising polymer strands of the substituted alginate strand of any of claims 16-18, cross-linked to other alginate polymer stands via calcium crosslinking.

20. A method of coupling an alginate strand to an functional moiety via carbodiimide coupling said method comprising conjugating the functional moiety to a linker comprising a nucleophilic group an amino group and a carboxyl group attached to the linker; wherein the functional moiety is chemically coupled to the linker; and coupling the amino terminus of the linker to the alginate strand via carbodiimide coupling; wherein the modification allows for synthesis of highly substituted alginate; wherein the substitution does not disrupt the integrity of the gel.

21. The method of claim 20, wherein the functional moiety comprise azide, tetrazine, alkyne, cyclooctyne, cycloocetene, norbornene, triazole, triazole-thiomorpholine dioxide, integrin-binding peptide, collagen-mimetic peptide, hydrazide, aldehyde, immunomodulating factor, angiogenesis-promoting factor, or cell-signaling factor.

22. The method of claim 20 or 21, wherein the nucleophile comprises amine, hydrazide, hydrazine, alcohol, thiol.

23. The method of any of claims 20-22, wherein the nucleophilic terminus of the linker comprise a protecting group; and wherein the nucleophilic terminus is deprotected prior to being coupled to the alginate strand.

24. The method of any of claims 20-23, wherein the protecting group comprise tert-butyloxycarbonyl, α-boc, p-methoxybenzyl carbonyl, carbobenzyloxy, acetyl, benzoyl, benzyl, carbamate, p-methoyxybenzyl, 3,4-dimethoxybenyl, p-methoxyphyl, trichloroethyl chloroformate, or tosyl.

25. The method of any of claims 20-24, wherein the carboxyl group of the linker comprise a protecting group; and wherein the carboxy terminus is deprotected after coupling to the alginate strand.

26. The method of any of claims 20-25, wherein the protecting group comprise methyl, ethyl, t-butyl, benzyl, benzyloxycarbonyl, s-Butyl, 2-Alkyl-1,3-oxazoline, OBO, silyl, photo-sensitive group.
